(19) United States
(12) Patent Application Publication
(10) Pub. No.: US 2025/0059445 A1
(43) Pub. Date: Feb. 20, 2025

(54) PYROLYSIS PROCESS FOR THE PRODUCTION OF A PYROLYSIS OIL SUITABLE FOR CLOSED LOOP RECYCLING, RELATED APPARATUS, PRODUCT AND USE THEREOF

(71) Applicant: Versalis S.p.A., San Donato Milanese, Milano (IT)

(72) Inventors: Riccardo FELISARI, San Donato Milanese, Milano (IT); Armando GALEOTTI, San Donato Milanese, Milano (IT); Mirco NODARI, San Donato Milanese, Milano (IT); Francesco BONACINI, San Donato Milanese, Milano (IT)

(73) Assignee: Versalis S.p.A., San Donato Milanese, Milano (IT)

(21) Appl. No.: 18/725,830

(22) PCT Filed: Dec. 27, 2022
(86) PCT No.: PCT/IB2022/062800

§ 371 Date: Jul. 1, 2024

(30) Foreign Application Priority Data
Dec. 30, 2021 (IT) 102021000033053

(51) Int. Cl. C10B 53/07; C10B 57/14

(52) U.S. Cl. CPC C10B 53/07; C10B 57/14

(57) ABSTRACT

The present invention relates to the treatment of plastic materials to be used for chemical recycling processes for the enhancement of substantially plastic materials otherwise destined for disposal.

Specifically, the invention relates to a process for the pyrolysis of substantially plastic material to obtain at least hydrocarbons that are liquid at 25° C., comprising the following steps:
a) feeding a substantially plastic material to a pyrolysis reactor;
b) bringing said material in said pyrolysis reactor to a temperature of between 330° C. and 580° C. in the substantial absence of oxygen and at a pressure of between atmospheric pressure and 13 bara;
c) maintaining said material in said pyrolysis reactor for a sufficient amount of time to produce an effluent in the gaseous state;
d) partially or fully condensing said effluent in the gaseous state, so as to form at least one fluid comprising hydrocarbons that are liquid at 25° C. and which quantitatively is at least 10% by mass with respect to the mass of substantially plastic material fed;
e) carrying out an assessment of at least one property “Px” of the liquid condensed from said effluent in the gaseous state by means of at least one measurement “Ax” of the spectrum in transmission, reflection or transflexion on said condensed liquid;
f) adjusting at least one process parameter “Ox” according to said assessment of at least one property “Px”;
g) repeating steps e) and f) iteratively so as to keep the said at least one property “Px” substantially constant over time.

The present invention relates to the treatment of plastic materials to be used for chemical recycling processes for the enhancement of substantially plastic materials otherwise destined for disposal.

Specifically, the present invention relates to a pyrolysis process for the production of a pyrolysis oil suitable for the closed-cycle recycling of plastics, its product and the use thereof.

The process of the present invention specifically refers to a pyrolysis process capable of treating plastic material of non-constant and/or inhomogeneous composition.

Advantageously, the present invention can be applied to treat substantially plastic pre-processed materials in a sorting plant, wherein certain types of plastics are identified and separated as individual polymers.

In this way, the recoverable fractions as a single type of polymer can be reused as such (through the so-called “mechanical” or “physical” recycling) and only the part not recoverable as a single polymer is subjected to pyrolysis. Following pyrolysis, hydrocarbons are produced which, subjected to further treatments, such as steam cracking, generate monomers which can then be polymerised, forming plastic again. This enables the plastic cycle to be closed, i.e., creating so-called “closed loop recycling”.

The recovery of said substantially plastic material, especially the residue after sorting, is particularly difficult, given that, having already selected what can be recovered as a single polymer (for example, polyethylene and polyethylene terephthalate), the residue is extremely varied and also includes non-plastic materials that are difficult to recover.

Through the method, apparatus and process disclosed in the present invention, which teach an innovative way of analysing said substantially plastic material, which is in itself very heterogeneous and to conduct pyrolysis according to the results of the analysis carried out, it is therefore possible to close the plastic cycle (thus also recovering said residue by “chemical” method) efficiently.

### KNOWN ART

There are many articles and patent applications on plastic material pyrolysis processes, but only a very small number also disclose measurement systems on the product obtained and its use to regulate the pyrolysis reaction.

For example, WO1991015762 describes a way of calculating the different components of a hydrocarbon compound by means of short infrared spectroscopy, especially the PLAN (molar content of paraffins, isoparaffins, aromatics, naphthenes and olefins), selecting, for each component of the PLAN, an interval of wavelengths to be measured. From this assessment, certain properties, such as octane number, can be predicted. The patent does not refer to pyrolysis processes.

Lastly, there are several patents and scientific articles that relate to the pyrolysis process carried out at pressures other than atmospheric pressure.

EP2348254 describes a “zero-emission” pyrolysis process conducted at 10-15 bar and, simultaneously, feeding a flow of pure oxygen.

ES2389799 discloses a process for the production of diesel oil (C13-C40) which foresees two stages, under pressure (1-15 bar). The first stage is thermal, whilst the second is catalytic and in the presence of hydrogen. The input material is preferably of polyolefin origin. It may contain polystyrene, but preferably the content of other plastics, such as PVC and PET, is less than 10%.

There are also multiple inventions that popularize pyrolysis carried out at reduced (sub-atmospheric) pressure, such as WO2013187788, WO0231082 and EP2184334.

The analysis of the prior art shows that the measurement of properties on the hydrocarbon product by infrared spectroscopy was used to determine the properties thereof, useful for application purposes (e.g., octane number) and/or to adjust subsequent conversion processes thereof.

Pyrolysis processes are also known, which work under conditions of residence times, temperature and pressure different from atmospheric pressure, for different types of input materials and different types of reactors. Extracting general lessons from this documentation is somewhat difficult. In fact, given the complexity of the process and the variety of solutions offered, it is difficult to identify general lessons.

However, a process is not known wherein the process parameters are adjusted in line, in order to maintain certain properties of the pyrolytic oil obtained constant, especially the viscosity and the refractive index, as the composition of the starting materials varies.

Furthermore, in no case does the material fed to the pyrolysis process have a composition that is not constant, i.e., that is variable over time and there is no teaching on how to modify the process to keep the product obtained constant with respect to properties such as viscosity and refractive index.

In addition, in no case is it known that, advantageously, said assessment is made on a fluid obtained by partial condensation of the product directly at the outlet of the pyrolysis reactor.

Lastly, it is not known that the refractive index and viscosity are optimal target parameters for identifying hydrocarbon compounds suitable for steam cracking in order to regenerate monomers useful for closing the plastic cycle.

The residual substantially plastic material, after a process of selection and extraction of single polymers, is, instead, by its nature, of very variable and inhomogeneous composition, as it is composed of multiple types of plastic materials, as well as non-plastic materials; furthermore, its composition is not constant between one charge and another, depending on its origin. These characteristics, especially in a continuous or semi-continuous process, entail a considerable variability of the composition of the pyrolysis product, which makes further processing necessary to obtain a product of the desired composition.

Furthermore, the pyrolysis processes require that the plastic fed to them has been previously selected so as to reduce the quantity of hard-to-treat plastics (such as PVC, PET, cellulose, polystyrene) and non-plastic materials, favouring, instead, polyolefins (especially polyethylene and polypropylene). However, most of the polyolefins contained in the substantially plastic material are usually separated in said selection processes and then recycled as such without having to perform a pyrolysis. There is therefore an interest in treating, under pyrolysis, above all the residual fraction after selection, which contains, in addition to polyolefins, significant quantities of the other plastics and smaller quantities of non-plastic materials.

It would therefore be desirable to have a process and relative apparatus capable of treating said substantially plastic material of non-constant composition, capable of producing a pyrolysis oil with properties such as to be advantageously usable in subsequent processes such as steam cracking in order to produce monomers that can be used again to produce polymers, in order to close the recycling cycle (“closed loop recycling”) and that said properties of said pyrolysis oil are controlled and included within the range required for effective use in said subsequent process.

### SUMMARY OF THE INVENTION

The Applicant has been able to develop a process for the pyrolysis of substantially plastic material to obtain at least hydrocarbons that are liquid at 25° C. by subjecting a substantially plastic material, that is also of a non-constant and inhomogeneous composition, optionally also comprising high quantities of components normally considered undesirable, to a pyrolytic process.

Said process for the pyrolysis of substantially plastic material to obtain at least hydrocarbons that are liquid at 25° C. comprises the following steps:
a) feeding a substantially plastic material to a pyrolysis reactor;
b) bringing said material into said pyrolysis reactor to a temperature of between 330° C. and 580° C., substantially in the absence of oxygen and at a pressure of between atmospheric pressure and 13 bara;
c) maintaining said material in said pyrolysis reactor for a time sufficient to produce, in said pyrolysis reactor, at least one effluent in the gaseous state;
d) partially or fully condensing said effluent in the gaseous state, so as to form at least one fluid comprising hydrocarbons that are liquid at 25° C. and which quantitatively is at least 10% by mass with respect to the mass of substantially plastic material fed;
e) carrying out an assessment of at least one property “Px” of the liquid condensed from said effluent in the gaseous state by at least one measurement “Ax” of the spectrum in transmission, reflection or transflexion on said condensed liquid;
f) adjusting at least one process parameter “Ox” according to said assessment of at least one property “Px”;
g) iteratively repeating steps e) and f) so as to keep said at least one property “Px” substantially constant over time.

A first advantage of the process disclosed in the present invention is the ability of the process to treat substantially plastic material of even highly variable composition, without the need to stop the process when the type of material is changed.

A further advantage of the process disclosed in the present invention is that, integrated in a pre-selection process, it allows for the recycling of plastic an indefinite number of times (“closed loop recycling”); that is, such that the material can be used and then regenerated several times without losing its properties during the recycling process.

A further advantage of the process disclosed in the present invention is the ability of the process to treat substantially plastic material comprising vinyl polymers (polyethylene and polypropylene), polyvinyl aromatic, such as polystyrene (PS) and alloys thereof, non-vinyl polymers, such as polyethylene terephthalate (PET), and oxygen-rich polymers (such as cellulose and said PET), without any process problems, such as fouling or occlusions and with high quality of said hydrocarbons that are liquid at 25° C.

A further advantage of the process disclosed in the present invention is the ability of the process to treat substantially plastic material also comprising high quantities of components normally considered undesirable, such as paper and cardboard (cellulose) and chlorinated or brominated compounds, such as polyvinyl chloride (PVC) and polymers containing halogenated flame retardants.

A further advantage of the process disclosed in the present invention is the ability of the process to handle substantially plastic material of non-constant composition, without fouling and occlusions occurring.

A further advantage of the process disclosed in the present invention is the ability of the process to treat substantially plastic material which is the residue that could not be separated and recycled in the sorting processes that are generally applied to plastic waste.

A further advantage of the process disclosed in the present invention is the ability of the process to produce a high quality pyrolysis oil in terms of the composition obtained, even when the substantially plastic material treated is of non-constant composition, maintaining a substantial high quality of the liquid hydrocarbons produced at 25° C.

An advantage of the apparatus disclosed in the present invention is the ability to operate continuously and for long periods of time without the need for maintenance and cleaning interruptions.

A further advantage of the process and apparatus disclosed in the present invention is that the latency time between the measurement of the spectrum “Ax” and the use of the same in the adjustment of the process parameter “Ox” (by calculating the property “Px”) can be very low. Specifically, said latency time can be set to a value not exceeding one hour, preferably not exceeding 10 minutes, even more preferably between 1 and 60 seconds.

A low latency time is desirable because it has, as an effect, both a faster correction of the process and, therefore, less product production outside the established objectives; and because, in a feedback control, the phase delay is reduced, thus making the control stable.

Existing processes, which do not use the process according to the present invention, are therefore normally carried out under constant conditions and, therefore, are substantially obliged to use a previously controlled and substantially constant quality fed plastic material, so as to obtain a product of relatively constant quality. Sometimes, empirically, experience is acquired regarding the optimal processing conditions as a function of the type of substantially plastic material. For example, it is assumed that the substantially plastic material deriving from a given supplier is of constant composition, so, over time, empirical process recipes (temperature, residence times, flow rate, etc.) are developed and optimised for substantially plastic material from a specific supplier.

Eventually, it would also be possible to carry out off-line measurements of the pyrolysis oil produced and adapt said process recipe according to the accumulated empirical experience. However, this mode is decidedly disadvantageous as inevitably the processing times of the analysis by a laboratory cannot be too short.

The object of the present invention is therefore to overcome or at least to alleviate the drawbacks of the state of the art outlined above.

The present invention also relates to a compound which includes hydrocarbons for at least 90% by weight with respect to the total weight of the compound, with a refractive index, measured according to the method defined below, of between 1.415 and 1.465 nD, preferably between 1.42 and 1.455, even more preferably between 1.425 and 1.45 and a viscosity, measured according to the method defined below, of between 0.7 and 1.2 cP, preferably between 0.8 and 1.1 cP, even more preferably between 0.85 and 1.05 cP and a content in tetrahydrofuran (THF) equal to no more than 1% by weight, preferably between 0.01% and 0.25% by weight, even more preferably between 0.07 and 0.19% by weight, with respect to the overall weight of the compound.

Advantageously, the tetrahydrofuran in the compound has solvent properties that reduce fouling in processes wherein the pyrolysis oil produced is used. In this way, for example, it is possible to reduce the “out of service” times for cleaning systems that use said pyrolysis oil, for example, by allowing a 10% reduction in “out of service” times of a steam cracking plant which uses said pyrolysis oil.

It was also surprisingly discovered that the pyrolysis oil obtained from the process of the present invention is characterised by low quantities of benzoic acid.

Benzoic acid, in large quantities, is in fact generally harmful in the processes of using pyrolysis oil, as it releases acidity and is produced in large quantities when the substantially plastic material fed to the process contains high quantities of non-vinyl polymers such as polyethylene terephthalate (PET).

In the state of the art, various processes have been proposed both for the recovery of benzoic acid downstream of pyrolysis and to reduce its production via catalytic conversion (see e.g., Shouchen Du et al., “Conversion of Polyethylene terephthalate based waste carpet to benzene-rich oild through thermal catalytic and catalytric steam pyrolysis”, ACS Sustainable Chem. Eng. 2016, 4, 5, 2852-2860, Apr. 11, 2016, doi https://doi.org/10.1021/acssuschemeng.6b00450).

Conversely, the process of the present invention allows to avoid such benzoic acid recovery processes, providing a pyrolysis oil which already comprises low quantities of benzoic acid.

Advantageously, the pyrolysis oil of the present invention has a benzoic acid content no higher than 2%, preferably between 0.01 and 1%, with respect to the total weight of the pyrolysis oil.

It has also been surprisingly discovered that the process of the present invention is characterised by a low production of certain non-linear alkenes.

It is known that alkenes are generally not desirable in pyrolysis oil, as they favour fouling and reduce the quality of the naphtha, measured, for example, using PONA or PIONA indices.

Advantageously, the pyrolysis oil covered by the present invention is characterised by an isobutene content (IUPAC name 2-methylpropene) no higher than 0.55%, preferably between 0.15 and 0.3%, with respect to the total weight of the pyrolysis oil.

The present invention also concerns the use of said compound to feed a cracking plant, especially a steam cracking plant, in order to produce monomers that can be used for the synthesis of polymers.

According to a preferred method, at least one property “Px” is the refractive index (“RI”) or viscosity (“VI”).

According to a preferred method, referred to as “multiple correlation”, there are at least two of the said at least one property “Px”. According to an even more preferred method, referred to as “double correlation”, there are two of the said at least one property “Px”.

According to this preferred double correlation mode, preferably the properties “Px” are the refractive index (“RI”) and viscosity (“VI”).

Preferably, said assessment of at least one property “Px” by means of at least one measurement of the spectrum “Ax” is carried out by means of the measurement of the spectrum “Ax” and the measurement of the temperature of the liquid on which the measurement is made.

Preferably, the reflection spectrum of said substantially plastic material obtained in step e) is in the range of between 4000 and 12000 cm⁻¹, more preferably in the range of between 4500 and 10000 cm⁻¹ and, even more preferably, it is in the range of between 5000 and 9000 cm⁻¹.

Preferably, said at least one measurement “Ax” of the spectrum is in transmission or transflexion; even more preferably, it is in transmission.

Preferably, said “liquid condensed from said effluent in the gaseous state” on which the measurement “Ax” of the spectrum is made is the liquid obtained by partial condensation of the effluent in the gaseous state of said pyrolysis reactor. Said method is hereinafter referred to as “control method on gaseous effluent leaving the reactor”. In this mode, said partial condensation can be preferably obtained by applying a cooling on at least a part of said effluent in the gaseous state. More specifically, said cooling can be achieved by passing a fluid at a lower temperature than said effluent in the gaseous state and such as to lead to an at least partial condensation thereof.

According to said “control on gaseous effluent leaving the reactor” method, preferably said effluent in the gaseous state of said pyrolysis reactor on which, after at least partial condensation, the spectrum measurement “Ax” is carried out are the pyrolysis vapours included within said pyrolysis reactor.

Again, according to said “control on gaseous effluent leaving the reactor”, even more preferably said effluent in the gaseous state of said pyrolysis reactor on which, after at least partial condensation, the measurement of the spectrum “Ax” is carried out are the pyrolysis vapours included in the pyrolysis vapour outlet duct from said pyrolysis reactor. Even more preferably, according to the latter method, said vapours are brought to the area where at least partial condensation occurs and said spectrum measurement “Ax” is performed within 2 minutes of the entry of said vapours into said reactor outlet duct, preferably between 1 and 60 seconds.

According to an embodiment, again according to said method, the measurement is carried out on-line, or in-line, as better specified below. The on-line mode is particularly preferred in this embodiment.

Alternatively, said “liquid condensed from said effluent in the gaseous state” on which spectrum measurement “Ax” is carried out is the liquid condensed in step d) of the process of the present invention.

If the condensation referred to in step d) is carried out in several stages, said “liquid condensed from said effluent in the gaseous state” can be the condensate of any stage. Preferably, in this multi-stage mode, said “liquid condensed from said effluent in the gaseous state” is the condensate of the last stage, that is, the one made at the lowest temperature.

Alternatively, again in the case of multi-stage condensation, said “liquid condensed from said effluent in the gaseous state” on which the “Ax” measurement of the spectrum is carried out is the liquid obtained from the union of the condensates of each stage, unless of any condensate recycled in said pyrolysis reactor.

The partial or total condensation carried out in step
d) is preferably such that at least 50%, even more preferably at least 75% of the pyrolysis vapours are condensed.

The process of the invention preferably involves obtaining at least one calibration curve “Cx” capable of correlating the spectrum in transmittance, transflectance or reflectance of the hydrocarbon liquid obtained from pyrolysis with the values of at least one property “Px” of said hydrocarbon liquid. Preferably, the calibration curve “Cx” is obtained by applying a multivariate regression method. Preferably, said multivariate regression method is Multiple Linear Regression (MLR), Principal Component Analysis (PCR) Regression or Partial Least Squares Regression (PLS). Even more preferably, multivariate regression is regression using partial least squares (PLS).

If the measurement is carried out in transmission or transflexion mode, preferably the optical path of the light is less than 25 mm, preferably between 3 and 18 mm, even more preferably between 5 and 15 mm, most preferably between 7 and 11 mm.

The measurement “Ax” is preferably carried out using a probe. Preferably, the probe used for the measurement is able to emit light, having a wave number at least in the range of between 4000 and 12000 cm⁻¹, more preferably in the range of between 4500 and 10000 cm⁻¹ and Even more preferably in the range of between 5000 and 9000 cm⁻¹.

### Definitions

In the description of the present invention, unless otherwise specified, the range values (for example, ranges of pressure, temperature, quantity, etc.) must be considered as including end values.

In the description of the present invention, unless otherwise specified, the percentages are to be understood by weight (i.e., by mass). The symbol “%” means percent, always by weight (mass).

In the description of the present invention, the term “comprising” also includes, as a particular limiting case, its meaning as “consisting of” or “consisting in”.

In the description of the present invention, the term “essentially consisting of” or “essentially consisting in” means that the composition or formulation (a) necessarily includes the listed ingredients and (b) is open to unlisted ingredients that do not materially affect the basic and new properties of the composition.

In the description of the present invention, a material is in the “molten state” at a given temperature if it is not in the solid state and has a flow index (MFR, melt flow rate), measured in accordance with ISO 1133-1: 2011, under a weight of 10 kg and at that temperature, over 2 grams in ten minutes.

In the description of the present invention, the “molten state” therefore also includes the liquid state.

In the description of the present invention, the term “sample spectrum” refers to a spectrum obtained on a sample material. In the description of the present invention, the term “hydrocarbons that are liquid at 25° C.” refers to hydrocarbon compounds which are in the liquid state at 25° C. and at atmospheric pressure.

In the description of the present invention, pyrolysis oil refers to the product of pyrolysis which is in the liquid state at 25° C. and at atmospheric pressure.

In the description of the present invention, the term “hydrocarbon liquid” refers to a liquid which comprises at least 90% by weight of hydrocarbons, with respect to the total weight of the liquid.

In the description of the present invention, the term “pyrolysis vapours” refers to the product which is generated during the pyrolysis process which is in the gaseous state in the pyrolysis reactor, i.e., which is in the gaseous state under the conditions of temperature, pressure and composition of the pyrolysis.

In the description of the present invention, the term “pyrolysis residue” refers to the product which is in the liquid, solid or liquid and solid state in the pyrolysis reactor, or in the liquid and/or solid state under the conditions of temperature, pressure and composition of the pyrolysis.

In the description of the present invention, unless otherwise specified, the term “value of a parameter or property equal to, at most, a certain value X” means that the parameter or property is equal to X or less than X; and for a value of a parameter (property) equal to at least a certain value X it is meant that the parameter or property is equal to X or greater than X.

In the description of the present invention, unless otherwise specified, the term “yield in the production of a product” refers to the percentage by weight of that product with respect to the total of products made.

In the description of the present invention, if not otherwise specified, the term “substantial absence of oxygen” means that the oxygen in the pyrolysis vapours is less than 2% by weight, preferably less than 0.8% by weight, even more preferably between 20 and 4000 ppm by weight, with respect to the total weight of the composition of said vapours.

Unless otherwise specified, in this document “part” and “parts” mean, respectively, part by weight and parts by weight. “Weight” refers to mass, i.e., kg in SI units.

### DESCRIPTION OF THE FIGURES

FIG. 1 shows the predictive ability of the calibration curve “Cx” corresponding to the property “Px” refraction index, for the 27 sample materials examined, where the “true” refractive index value is shown on the abscissa, i.e., that determined by the primary analysis E the ordinate shows the refractive index value calculated using the corresponding calibration curve “Cx” (“predicted”);

FIG. 2 shows the predictive capacity of the calibration curve “Cx” corresponding to the viscosity property “Px”, for the 23 sample materials examined, where the “true” viscosity value is shown in the abscissa from the primary and ordinate analysis, the viscosity value calculated with the corresponding calibration curve “Cx” (“predicted”) is shown;

FIG. 3 shows the predictive capability of the calibration curve “Cx” corresponding to the refraction index property “Px” and viscosity, for the PLS (Partial Least Squares) regression, where
the number of main components used (NC) is shown on the abscissa and where
the root mean square error in cross validation (RMSECV) is shown on the ordinate; the unit of measurement is that corresponding to the property “Px”, therefore, the left ordinate scale is [nD], i.e., refractive index unit and the right ordinate scale is [cP], i.e., centiPoise;

FIG. 4 shows, in superposition, 100 spectra acquired on pyrolysis oils of the present invention, where the wave number (in cm⁻¹) is shown on the abscissa, whilst the absorbance is shown on the ordinate;

FIG. 5 schematically shows an apparatus for the pyrolysis of substantially plastic material to obtain at least hydrocarbons that are liquid at 25° C. according to the invention;

FIG. 6 shows an embodiment of the split range control mode according to the present invention;

FIG. 7 shows an example of embodiment of the mode for the in-line acquisition of the absorption spectra of the vapours of pyrolysis condensates;

FIG. 8 shows the same example of implementation of the mode for the in-line acquisition of the absorption spectra of condensed pyrolysis vapours shown in FIG. 7, but in section.

### DETAILED DESCRIPTION OF THE INVENTION

The invention primarily concerns a process comprising the following steps:
a) feeding a substantially plastic material to a pyrolysis reactor;
b) bringing said material in said pyrolysis reactor at a temperature of between 330° C. and 580° C. in the substantial absence of oxygen and at a pressure between atmospheric pressure and 13 bara;
c) keeping said material in said pyrolysis reactor for a time sufficient to produce at least one effluent in the gaseous state in said pyrolysis reactor;
d) partially or fully condensing said effluent to the gaseous state, so as to form at least one fluid comprising hydrocarbons that are liquid at 25° C. and which, quantitatively, is at least 10% by mass with respect to the mass of substantially plastic material fed;
e) carrying out an assessment of at least one property “Px” of the liquid condensed from said effluent in the gaseous state by means of at least one measurement “Ax” of the spectrum in transmission, reflection or transflexion wherein said “Ax” measurement is performed directly on said condensed liquid by means of a spectrometer or spectrophotometer;
f) adjusting at least one process parameter “Ox” according to said assessment of at least one property “Px”;
g) iteratively repeating steps e) and f) so as to keeping said property “Px” substantially constant over time.

The spectrum of step e) is an absorbance spectrum and can be determined by a spectrometer in transmission (transmittance), transflexion (transflectance) or reflection(reflectance) mode.

In transmission spectroscopy, the radiation analysed by the spectrometer is the fraction of the incident radiation that passes through the sample, i.e., the fraction that is neither absorbed nor reflected by the latter.

In transflectance spectroscopy, the radiation analysed by the spectrometer is the fraction of the incident radiation which, after passing through the sample, is reflected by a special reflecting screen placed in the measurement cavity along the path of the radiation, beyond the sample; the radiation reflected from the screen passes through the sample a second time, before reaching the spectrometer.

In reflection spectroscopy, the radiation analysed by the spectrometer is the fraction of the radiation reflected by the sample. It is usually mostly diffuse radiation.

Preferably, said spectrometer is a spectrophotometer, that is, it is equipped with a system for the quantitative measurement of light intensity.

There are no specific limitations on the type of spectrometer or spectrophotometer. For example, spectrometers with prism or grating monochromator, or Fourier transform spectrometers, known as FTIRs, can be used.

Monochromator spectrometers can advantageously comprise a series of photodiodes (“photo diode array” or PDA, otherwise also known as “diode array”). Said spectrometers are also known by the term “DAS” (diode array spectrometer) or PDAS (photo diode array spectrometer). Alternatively, sensors and corresponding CCD (charged-coupled device) spectrometers can also be used.

The sample of substantially plastic material to be measured is illuminated by a broad spectrum light source, that is, which includes all the frequencies included in the range of wave numbers being measured.

Said spectrum is preferably in the visible spectrum, i.e., between 12000 and 25000 cm⁻¹, in the near-infrared (NIR), i.e., between 4000 and 12000 cm⁻¹ and/or in the mid-infrared (MIR), i.e., between 400 and 4000 cm⁻¹. More preferably, said spectrum is between 4000 and 12000 cm⁻¹, even more preferably in the range of between 4500 and 10000 cm⁻¹ and even more preferably in the range of between 5000 and 9000 cm⁻¹.

The detection probe receives part of the transmitted or reflected light from the sample of material illuminated by said light source and is then brought to a spectrum analyser for measurement. Therefore, the detection probe is typically optically coupled with the emitting probe, i.e., it is positioned and oriented so that the former receives the transmitted or reflected light emitted by the transmitter probe.

There are integrated devices that enable both the emitting and the receiving probe to be included in the same device. This is particularly the case for probes that work in reflectance or transflectance. In the case of transmitting probes, however, there are typically two separate devices, typically positioned along a diameter of the pipe wherein the fluid to be measured flows, at 180° from each other and at a predetermined distance from each other. In fact, in this way, it is possible to establish a precise optical path, typically less than 20 mm, even more preferably between 5 and 15 mm.

Advantageously, the apparatus for measuring at least one property “Px” of a hydrocarbon liquid can be used continuously and for a long period of time. Therefore, a preferred method of the present invention is the pyrolysis process of substantially plastic material in continuous or semi-continuous batch.

The term “keeping substantially constant over time” as regards the property “Px” means that the property “Px” is kept in the vicinity of the target value or range of values. The width of the surroundings depends on the property “Px”. According to one embodiment, said vicinity is no more than the maximum of between 15% of the target value and 15% of the variation of the property “Px” observed when the substantially plastic material under unchanged process conditions passes from a first composition comprising 100% polyethylene to a second composition comprising 65% polyethylene, 25% polystyrene, 5% cellulose and 5% polyethylene terephthalate. In the event that said property “Px” is the refractive index “RI”, in a preferred embodiment, said amplitude of the vicinity is equal to 0.02 nD, even more preferably 0.01 nD. Therefore, if, for example, the target value of the refractive index is 1.43 nD, according to said embodiment, “keeping substantially constant over time” means that the refractive index is preferably maintained between 1.42 nD and 1.44 nD, even more preferably between 1.425 and 1.435 nD.

In the event that said property “Px” is the viscosity “VI”, in a preferred embodiment said amplitude of the vicinity is equal to 0.2 cP, even more preferably 0.1 cP.

According to one embodiment, the term “iteratively repeating steps e) and f)” means that steps e) and f) are repeated at least once every hour, preferably at least once every 15 minutes, even more preferably at least once every 10 minutes, specifically between 10 seconds and 5 minutes.

To apply the method according to the present invention to the control of the pyrolysis of the substantially plastic material it is necessary to have at least one calibration curve “Cx” capable of correlating the spectrum in transmittance, transflectance or reflectance of the hydrocarbon liquid obtained from pyrolysis with the values of at least one property “Px” of said hydrocarbon liquid.

Preferably, said at least one property “Px” of said hydrocarbon liquid is the refractive index (“RI”) and/or viscosity (“VI”).

The calibration curve can be obtained with the methods known to the skilled in the art. The calibration curve can be obtained by univariate regression methods. Preferably, the calibration curve can be achieved by multivariate regression methods.

To obtain the calibration curve, for example, a plurality of hydrocarbon liquids can be prepared to be used as calibration samples (hereinafter referred to as “sample materials”), each of which is subjected to at least one primary analysis capable of determining the value of said at least one property “Px”.

According to the present invention, the primary analysis for the refractive index “RI” is measured using the following methods:

Instrumentation used: Anton Paar Abbemat 300 digital diffractometer, equipped with software version 1.30, with LED illuminator at 589.3 nm, measurement range from 1.26 to 1.72 nD, with an accuracy of +/−0.0001 nD, resolution of 0.00001 nD, temperature control with a resolution of 0.01° C., an accuracy of +/−0.05° C. and a stability of +/−0.002° C.

The procedure for the measurements corresponds to that indicated by the supplier, in particular in chapter 9 “Measuring” of the manual attached to the instrument “Instruction Manual and Safety Information Abbemat 300/500”. Specifically, the height filled by the liquid is 1 mm for a volume corresponding to approximately 1 ml, as indicated in this manual. The measurements were carried out at a set temperature of 20.00° C.

According to the present invention, the primary analysis for viscosity “VI” is measured with the instrumentation and the following method:

The instrument used for viscosity measurement is the DVE digital viscometer model DVE-ELVTJO produced by Brookfield Ametek. The “Enhanced UL Adapter” for low viscosity liquids was also used for the measurements and a temperature ranging from 1 to 65° C., which therefore also acts as a “container”. The measurements were carried out at a temperature of 28° C. and at a speed of 100 rpm. The “ELV” model therefore does not correspond to the “LV” model which according to the manual operates at a maximum speed of 60 rpm. A spindle with code “00” was used. The amount of liquid poured is not less than 16 mL (in order to immerse the whole “spindle” and reach the notch thereon). The maximum is no more than 18 ml. The viscosity value is read after 90 seconds of operation. Viscosity measurements are in centipoise (cP).

The refractive index and viscosity values of the pyrolysis oil, as well as the relative ranges indicated in the present invention, are therefore understood to refer to the instrumentation and measurement procedure indicated.

According to the present invention, the number of sample materials used to define the calibration curve is equal to at least 5, more preferably, at least 10. In a particularly preferred embodiment, the number of sample materials is between 15 and 50.

Advantageously, liquid hydrocarbons obtained from the pyrolysis of substantially plastic material of different types and processed under different operating conditions (residence time, temperature, pressure) can be used.

For example, said substantially plastic materials used to produce said sample hydrocarbon liquids, they can be blends of polymers comprising polyethylene, polypropylene, polyvinyl chloride, polystyrene, polyurethane, polyethylene terephthalate and cellulose in various ratios.

The use of various substantially plastic materials that come from the plastic recycling chain, to which quantities up to 20%, preferably from 1% to 10% of the aforementioned polymers are added, is particularly preferred. In this way, it has been discovered that it is possible to create a robust calibration curve, that is, it is effective even when there is a considerable variability of composition of the substantially plastic material fed to the pyrolysis reactor.

There are no particular limitations regarding the spectrum meter used. Preferably, said spectrum meter is a spectrophotometer. Even more preferably, said spectrophotometer is a Fourier transform (FTIR) or diode array or dispersion spectrophotometer.

In all cases, the spectrum is typically obtained in digital form. In particular, typically the digital spectrum obtained includes the values of the spectrum for a discrete number of wave numbers, also referred to as channels. Advantageously, as regards the diode array spectrophotometer, said channels can correspond to individual diodes.

Advantageously, the light radiation reflected by the sample analysed and collected by the detection system can be elaborated, according to the techniques known to those skilled in the art, in the form of a reflectance spectrum (R) or preferably of absorption (A) as a function of the wave number of the incident radiation (typically expressed in cm⁻¹) or as a function wavelength (typically expressed in nm). Absorption (A) is calculated starting from the measured value of reflectance (R) based on the relation A=log (1/R), where “log” is the natural logarithm.

Once obtained, the calibration and measurement spectra can be pre-processed with the methods known in the art to correct any spectral distortions due, for example, to baseline shifts.

To determine a given calibration curve “Cx”, the calibration spectra and the values of the property “Px” (already determined or in any case known for the sample materials as explained above) are analysed using statistical-mathematical methods known of univariate and/or multivariate linear regression or in general by applying Machine Learning (ML) models such Artificial Neural Networks (ANN), Genetic Algorithms (GA), Fuzzy logic, Particle Swarm Optimisation (PSO) and combinations thereof.

Preferably, the multivariate linear regression method is chosen from the following: Multiple Linear Regression (MLR) method, Partial Least Squares (PLS) method, Principal Component Regression (PCR) method and combinations thereof.

According to one method, the calibration curve resulting from the application of the aforementioned multivariate regression methods can be a linear combination of absorbances or other quantities derived from the latter.

Therefore, according to this method, for each sample spectrum, the following equation can be written, hereinafter referred to as the “linear regression equation”:

$${Px}_{j} = {k}_{0} + {\sum }_{i = 1}^{N} {k}_{i} \cdot {A}_{ji}$$

$$j ϵ [ 1 , M ]$$

where:
“M” is the number of sample spectra assessed;
“j” is the representative index of the sample spectrum “j” carried out on a specific sample material “k” (as mentioned, preferably more sample spectra are assessed for each sample material);
Pxⱼ is the value of the Px property for the sample material “k” used in the measurement of the sample spectrum “j”
“i” is the channel number
“N” is the number of channels, that is, the number of discrete wave numbers that make up the spectrum
Aⱼᵢ is the absorption of channel “i” (corresponding to the absorption at the wavelength Ai) measured on the “j” spectrum, or other quantity derived from the absorbance
kᵢ with i in the range from 0 to N are the coefficients of the calibration curve (Cx) to be found.

We therefore have M equations (one for each sample spectrum assessed) in N+1 unknowns (the coefficients kᵢ) If the number of sample spectra M is greater than N+1 and if there are no linearly dependent sample spectra (i.e., a linear combination of two or more other spectra), mathematically, it is possible to regress the system of M equations obtaining the values of the coefficients kᵢ. This is the multiple linear regression (MLR) method.

However, it is preferable to reduce the number of N+1 unknowns, because many unknowns are actually not linearly independent. For example, the signal relating to the absorption of the double bond of the carbon atom in ethylene has several higher harmonics (“overtone”), so the presence of this double bond increases the absorbance signal on different channels.

Therefore, according to a preferred modality of the present invention, the number of unknowns is reduced by using multivariate analysis methods.

According to a first method, the data relating to the absorption of the sample spectra are subjected to a principal components analysis (PCA). Preferably, they are extracted from 4 to 15 main components, even more preferably 5 to 11 main components.

The model is then obtained with the linear regression equation defined above, where, however, “Aⱼᵢ” represents the value (“score”) of the main component “i” relative to the sample spectrum “j”. This mode of application of the PCA is referred to as the “principal component regression” (PCR).

According to a further, more preferred method of the present invention, the data relating to the absorptions of the sample spectra and those of the property Pₓⱼ are subjected to the partial least squares (PLS) regression.

In fact, the use of property Pₓⱼ information in the regression enables the determination of the main components capable of maximally describing the variability of the regressed parameter Pₓⱼ.

As for PCR, according to this method, preferably from 4 to 15 main components are extracted, even more preferably from 5 to 11 main components.

The model is then obtained with the linear regression equation defined above, where, however, “A_{JI}” represents the value (“score”) of the main component “i” relating to the sample spectrum “j”, this time obtained by PLS.

The calibration curve “Cx” obtained from multivariate regression analysis (for example, MLR, PCR or PLS) is subsequently subjected to validation using a series of spectra prepared in the same way as the sample spectra used to determine the calibration curve “Cx”, i.e., made on hydrocarbon liquids a property “Px” that can be determined using a primary analysis as described above.

The inventors have developed a so-called “rotation” mode that enables a calibration curve to be obtained that is particularly effective in predicting the “Px” control parameters, specifically the refractive index “RI” and viscosity “VI”.

According to this method:
a) the sample spectra are divided so that from 1% to 40% (in number) of the spectra, preferably from 10% to 30%, are used for validation, and the rest for calibration;
b) multivariate regression is performed, preferably PLS or the PCR, on the spectra selected for calibration, carrying out the validation on the spectra selected for validation, calculating the mean square error of the property “Px”;
c) the sample spectra are again subdivided so that 1% to 40% (in number) of the spectra, preferably from 8% to 25%, are used for validation and the rest for calibration, selecting spectra for validation from those that have not been previously selected for validation;
d) the multivariate regression is repeated on the new selection of spectra for calibration and the validation on the new selection of spectra for validation;
e) a new loadings matrix is calculated, wherein each element of the matrix corresponds to the average of the corresponding elements of the single load matrices obtained in steps b) and d).

Once validated, the calibration curve can be used to calculate the value of the control parameter “Px”, such as the refractive index “RI” or the viscosity “VI”, applying it to an in-line acquired spectrum. If multivariate regression methods were used, from the discrete values of the absorbances it is possible to calculate the values (scores) of the same main components of the PCA and/or PLS previously identified during the determination of the calibration curve “Cx” (i.e., using the same “loadings” matrix).

In the production phase (i.e., in the pyrolysis process according to the present invention) the spectrum analyser can be advantageously connected to a control system, such as a computer, a calculation server, a distributed control system (DCS), a programmable logic controller (PLC) or a field programmable gate array (FPGA).

The spectrum analyser is capable of performing spectrum measurements in a very short space of time, typically in less than one minute. The calculation of said at least one parameter Px by means of said at least one calibration curve Cx is also very fast, generally consisting of a relatively small number (for an electronic computer) of algebraic operations. The control system can also be extremely fast. Therefore, the entire sequence of operations (from the analysis “Ax” to the calculation of the process parameter “Ox”) can be carried out in a very short space of time, less than a minute, or even a few seconds.

According to the present invention, it is preferable to repeat the acquisition of spectra at a high frequency, preferably at least 10 per hour, preferably at least 30 per hour, even more preferably from 60 to 3600 per hour and even more preferably from 120 to 900 per hour.

According to the present invention, it is preferable to acquire a series of spectra in order to calculate an average parameter Px from switching to the process controller to calculate the process parameter “Ox”.

Preferably, said substantially plastic material fed to the pyrolysis reactor consists of compositions of different plastics. Even more preferably, said compositions of different plastics include at least high H/C index polymers such as for example polyethylene, polypropylene, polyamides, polymethylmethacrylate and low H/C index polymers such as polystyrene, polycarbonate, polyethylene terephthalate.

Alternatively, or in combination, said compositions of different plastics include high carbon index polymers such as polyethylene (including LDPE, LLDPE, HDPE), polypropylene, polystyrene, elastomers, and low carbon index polymers such as polyamides, polymethyl methacrylate, polyethylene terephthalate, polyvinyl chloride and cellulose.

Preferably, said substantially plastic material is characterised by an H/C index (H/C index) equal to at least 70, preferably between 80 and 98, even more preferably between 85 and 96.

Preferably, said substantially plastic material is characterised by a carbon index equal to at least 55, preferably between 65 and 95, even more preferably between 75 and 90.

The H/C index (H/C index) and the carbon index (carbon index) are calculated with the following expressions:

$$H / C Index = 100 \cdot \frac{12}{2} \cdot \frac{Weight atoms H}{Weight atoms C}$$

$$Carbon Index = 100 \cdot \frac{Weight atoms C}{Weight atoms ALL}$$

where “Weight atoms” means the total mass of the atom indicated in the material (or of all atoms for “All”, i.e., the mass of the material).

Said substantially plastic material can also contain at least one non-plastic material in an amount of between 0.01% and 10% by weight with respect to the weight of the substantially plastic material, or in an amount of between 0.05% and 7.5%, or in an amount of between 0.2% and 5%. Said non-plastic material may include at least one of the following materials: paper, cardboard, wood, compost (as defined by the IUPAC in “Terminology for biorelated polymers and applications (IUPAC Recommendations 2012)”, Pure Appl. Chem., Vol. 84, No. 2, pp. 377-410, 2012, DOI 10.1351/PAC-REC-10-12-04), metallic materials such as aluminium and iron and/or inert materials.

Said substantially plastic material can also contain inorganic fillers such as silica, titanium oxide, talc, coke, graphite, carbon black, calcium carbonate. In certain embodiments, said fillers can be present in an amount of 0.01-10%, preferably 0.1-5%, with respect to the total weight of the substantially plastic material.

In certain embodiments, the substantially plastic material has a final inorganic residue (ash), measured according to the method described herein, of at least 0.01%, preferably between 0.1% and 20%, more preferably between 0.4 and 12%, even more preferably between 1.1% and 7%, with respect to the weight of the substantially plastic material.

Said substantially plastic material can also contain brominated and chlorinated additives used to make the plastic material fireproof or in any case impart flame retardant properties. Examples of said additives are hexabromocyclododecane, decabromodiphenyloxide, polybrominated diphenyl ethers and brominated polymers such as brominated styrene-butadiene copolymers or brominated polystyrene.

Said substantially plastic material can also contain non-halogenated additives used to make the plastic material fireproof or otherwise impart flame retardant properties, such as phosphorus and nitrogen compounds.

If the substantially plastic material contains one or more of said materials or substances, the pyrolysis process according to the invention is not negatively affected.

“Non-constant composition” means that the composition is variable between different production batches.

Alternatively or in combination, the composition is not constant because, even within the same batch, there is variability of the composition, for example due to the stratification of the material. In fact, during transportation, there can be stratification, which generally determines an increase in the concentration at the bottom of the heavier and/or small-sized or powdery plastics and at the top of the lighter and/or large-sized plastics.

Alternatively, said substantially plastic material is not of constant composition as it is supplied by different manufacturers or suppliers. Each manufacturer can have different production specifications and/or different production processes, therefore the product obtained is different.

Preferably, said substantially plastic materials are recycled.

Preferably, said substantially plastic materials also contain halogenated components in amounts of between 0.01% and 10% by weight with respect to the weight of the substantially plastic material.

Preferably, said substantially plastic materials are obtained by a plastic material sorting process. Even more preferably, said substantially plastic materials are the substantially plastic material remains, i.e., the substantially plastic fraction that remains after having recovered some plastics, that is, after having selectively extracted certain plastics from the substantially plastic material fed to the sorting process. Selective extraction involves the substantially same-material (i.e., single-plastic) extraction of certain plastics. Typically in a sorting process, substantially pure plastic streams (i.e., single-plastic streams) of the polyethylene, polypropylene and polyethylene terephthalate components can be extracted. In this preferred selection, the residual substantially plastic material is therefore the material that results after the extraction of said substantially pure plastics. This fraction is known, in Italy, by the term “Plas Mix” or “Plasmix”, which is defined as the “set of heterogeneous plastics included in post-consumer packaging and not recovered as individual polymers” (Article 1, draft law Parliamentary Act No. 4502 dated 18 May 2017).

This substantially plastic material can be further selected to eliminate non-recyclable materials or used as such. Specifically, according to a preferred method, said substantially plastic materials, optionally obtained from a process involving the sorting of plastic material as defined above, are pretreated before being used in the pyrolysis process of the present invention.

This pre-treatment preferably comprises a wash to remove at least part of the organic matter. Preferably, said pre-treatment alternatively, or in combination, also includes the elimination of non-organic solid particulate, such as ferrous material and crushed stone.

The fluid comprising hydrocarbons obtained from pyrolysis which is in the liquid state at 25° C. is also referred to as pyrolysis oil.

### Preferred Methods of the Process of the Present Invention

According to a preferred method, said measure of at least one property “Px” on the hydrocarbon liquid is carried out on the vapours leaving the pyrolysis reactor, or contained therein, after at least partial condensation, in in-line or on-line mode, whilst the off-line mode is excluded.

In the on-line mode, the measurement of the property “Px” is carried out by means of a bypass, or by taking the sample of vapours to be measured from the pyrolysis reactor, or downstream therefrom (for example, on the pyrolysis vapour outlet duct). Said sample of vapours to be measured is therefore at least partially condensed and the measurement of the property “Px” is carried out on the condensate. Typically, the condensed sample and any remaining vapours are then returned to the pyrolysis reactor or downstream thereof.

In the in-line mode, on the other hand, the measurement of the property “Px” is carried out on a condensate of the main flow of pyrolysis vapours, i.e., not by means of a bypass. Therefore, in the in-line mode, the measurement is carried out directly inside the pyrolysis reactor, or directly inside the vapour outlet duct from said pyrolysis reactor, after at least partial condensation.

Said at least partial condensation can be achieved with any method known in the art. Advantageously, it can be carried out using a coil wherein a fluid placed at a temperature at least lower than the condensation temperature of 50% by weight of the hydrocarbon liquid to be measured. According to an alternative method, said partial condensation can be carried out by wall cooling, where this wall, in the case of the on-line mode, is the duct through which the steam to be condensed flows, or the wall of a vessel where said vapour is made to pass and where the liquid is accumulated, or again, in the case of the in-line mode, the same wall of the reactor or of the pyrolysis vapour outlet duct from said pyrolysis reactor.

According to the present invention, it is also preferred that the probe carrying out the measurement is completely flooded. “Completely flooded probe” means that the level of the condensed hydrocarbon liquid must be greater than the level of the probe, so that all of the light detected by said probe has passed, at least partially, through said condensed hydrocarbon liquid. It can be ensured that the hydrocarbon liquid level always remains above the probe level, regardless of the condensing capacity, by applying a weir.

According to one embodiment of the present invention, the assessment of the property “Px” is carried out on-line, wherein the vapours to be measured are taken from the reactor or from the pyrolysis vapour outlet duct. Particularly preferred is the mode wherein:
a stream of pyrolysis vapours is taken from the pyrolysis vapour outlet duct from the pyrolysis reactor;
said flow of withdrawn vapours is sent to a condenser so as to condense at least 50%, preferably at least 75%, of the vapours;
the spectrum “Ax” is measured on the condensed fluid (preferably in the lower part of the condenser, which acts as a liquid storage capacity);
the vapour is sent into the pyrolysis reactor, sent into said pyrolysis vapour outlet duct or sent to the remaining pyrolysis vapours before the condensation thereof in step d) of the process, thus carrying out the reunification of the pyrolysis vapours; preferably, the vapour is sent to the remaining pyrolysis vapours before the condensation thereof;
the liquid, preferably by gravity, is sent into the pyrolysis reactor or into said pyrolysis vapour outlet duct, thus returning the liquid into the main flow. Alternatively, instead of gravity return, the return can be performed using a pump.

According to an alternative embodiment, the measurement of the property “Px” is carried out in-line. In a preferred method to the in-line mode, the measurement is carried out on a condensate in a section of piping interposed between the outlet of vapours from the pyrolysis reactor and the duct that carries said vapours to the next unit (for example, a second reactor or a condenser). Advantageously, in this way, it is possible to carry out the thorough cleaning of the septum where the condensation of the vapours takes place. Preferably, in this method, the pipe section corresponding to the vapour outlet has less insulation, or is even not insulated, so as to allow for the condensation of part of the vapours, by transferring heat to the surrounding environment, typically at a much lower temperature than the pyrolysis vapours and, therefore, without the need for a jacket or coil. In an alternative method, however, a cooling system, such as jacket or coil, is also provided, so as to obtain a greater and more controlled condensation.

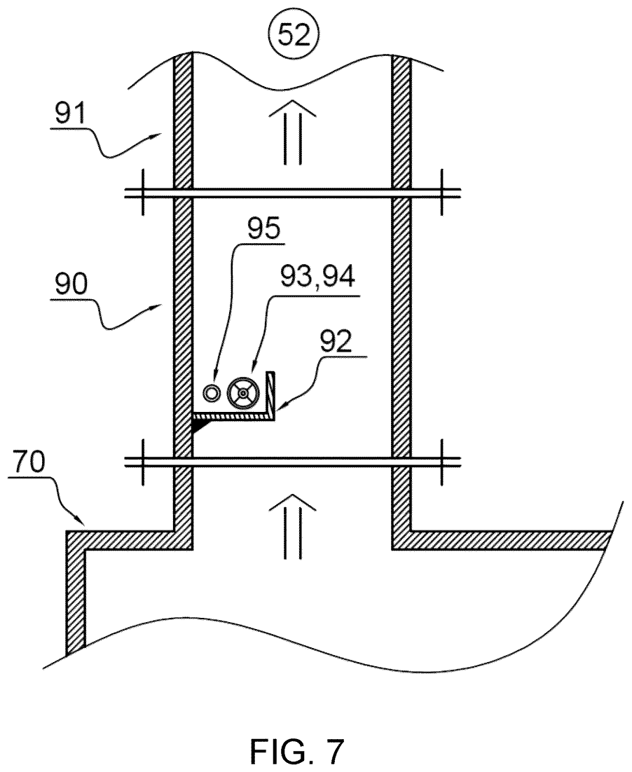

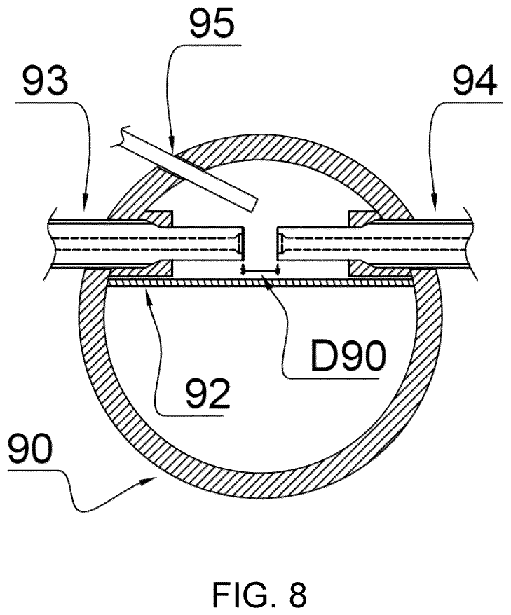

FIGS. 7 and 8 show an embodiment of the in-line mode on an interposed pipe section, wherein the detail of the bulkhead and probes (92,93,94,95) are intentionally not to scale with respect to the diameter of the pipe (90) for greater visual clarity.

With reference to FIG. 7:

(70) is the pyrolysis reactor; (52) is the pyrolysis vapour flow exiting the pyrolysis reactor; (91) is the relative pipe section; (90) is a section of pipe interposed between said pipe (91) which carries said pyrolysis vapours and the reactor (70); (92) is an L-shaped angular profile solidly fixed to said section of pipe (90); (93) and (94) are the probe for the emission and detection of the spectrum in transmission; (95) is a probe for detecting the temperature of the condensate.

With reference to FIG. 8:

(90) is a section of pipe interposed between said pipe, (92) is the angular profile (93) and (94) are the emission and reception probe, opposite each other and (95) is the probe for measuring the temperature; D90 is the distance between (93) and (94) and is the optical path travelled by light in the hydrocarbon liquid.

The vapours leaving the reactor (70) are partially condensed on the walls of the pipe section (90) (as a result of said jacket, cooling coil or by simple reduction of the insulation, as explained above). The angular profile (92) forms a bulkhead which keeps the emission and detection probe (93,94) and the temperature measurement probe (95) flooded. By weir, excess condensed hydrocarbon liquid falls back into the reactor.

According to one embodiment, the angular profile (92) comprises sufficiently small holes to facilitate the slow emptying of the liquid when the process is stopped, whilst preventing it from emptying during the process. For example, between 1 and 10 holes with a diameter of between 1 mm and 10 mm can be used.

According to a preferred method, said probe capable of emitting light consists of one or more optical fibres. According to a further preferred method, the detection probe also consists of one or more optical fibres.

Preferably, the temperature of the condensed hydrocarbon liquid is measured and the detected value is used for the calculation of said property “Px”. In this method, the temperature value is used both in the regression phase to determine said calibration curve “Cx”, as an additional variable on which to perform the regression, both, in the operational phase, as an additional variable used to calculate the property “Px”.

Said means for measuring the temperature can be any means known in the art, such as for example a thermocouple, a thermoresistance (such as a “PT100” or a “PT1000”) or an infrared measurement.

Preferably, the substantially plastic material fed to the reactor in step a) is brought, at least partially, to the molten state by heating in a so-called preheating device. Said preheating device can be a single screw extruder, a twin screw extruder or an auger. Said preheating device can be equipped with degassing for the evacuation of water vapour and any other gases produced, such as in particular hydrogen chloride (HCl).

For this purpose, it may be advantageous to feed said preheating device, in addition to said substantially plastic material, including additives capable of facilitating the evolution of hydrochloric acid or to salify it. Said additives are preferably composed of the elements of group IA and IIA. Even more preferably, they are the oxides, hydroxides, carbonates, silicates and aluminosilicates of groups IA and IIA. Even more preferably, they are calcium oxide, calcium hydroxide, calcium carbonate, sodium oxide, sodium hydroxide, sodium carbonate, potassium oxide, potassium hydroxide, potassium carbonate, sodium aluminosilicate.

The preheating temperature can be between 12° and 430° C., preferably between 150 and 320° C., even more preferably between 18° and 220° C. The residence time in said preheating device is preferably less than 10 minutes, even more preferably less than 2 minutes, specifically less than one minute. The maximum pressure reached by the substantially plastic material in said preheating device is preferably at least 2 bara, even more preferably between 5 and 300 bara and, even more preferably, between 10 and 50 bara.

Therefore, according to a preferred method of the process of the present invention, said substantially plastic material, at least partially in the molten state, is obtained by means of a preheating apparatus, preferably an auger or an extruder.

Said process for the pyrolysis of substantially plastic material to obtain at least hydrocarbons that are liquid at 25° C. can be carried out both in batch mode, in continuous mode and in semi-continuous mode. In the latter mode, the substantially plastic material is loaded continuously, the vapours generated are extracted continuously, but any solid residue is kept inside the pyrolysis reactor.

When the amount of solid residue inside the reactor rises above a certain threshold, or at predefined time intervals, for example, with a frequency of between 2 and 10 days, the material contained in the reactor and, therefore, said solid residue, is removed.

Preferably the reactor is managed in continuous or semi-continuous mode, even more preferably in semi-continuous mode.

The pyrolysis process of the present invention is not limited by a specific type of reactor.

Specifically, horizontal or vertical reactors, stirred or non-stirred, rotary reactors (kiln reactor) or screw reactors can be used.

Amongst the continuously stirred reactors (CSTR), fully filled reactors can be used, as can reactors in which a separation of the gaseous phase from the phase that includes the liquid and other possible phases such as the solid (char) produced, or reactors in which there is a free surface.

Preferibilmente il reattore è un reattore agitato. Preferably, the reactor has a free surface, i.e., a surface which substantially separates the gaseous phase from the substantially non-gaseous phase. The substantially non-gaseous phase is, for example, the phase comprising the solids, the liquids; liquids also meaning the molten material such as, for example, the substantially plastic material fed. Said substantially non-gaseous phase may in any case comprise the gaseous phase, for example, the bubbles from the vapours of the products of the pyrolysis that go back into the reactor.

The temperature to which the material is brought in said pyrolysis reactor is from 330° C. to 580° C., preferably from 340 to 540° C., more preferably from 360 to 500° C., even more preferably from 380 to 480° C., most preferably from 410 to 450° C.

The temperature of the material in the pyrolysis reactor can be measured using any method known in the art. For example, it is possible to use thermocouples with a facing membrane aligned with the internal surface of the reactor, in order to reduce fouling; or thermocouples in the well for a more precise measurement inside the reactor; or thermocouples that measure the temperature of the metal near the surface of the reactor wetted by the polymer; or non-contact measuring systems, such as infrared. Multiple systems can be used simultaneously for better reliability.

The temperature can be adjusted by acting on the thermal power introduced into the reactor. Said thermal power can be introduced through the use of any technique known in the art, such as a reactor fitted with a heating jacket into which a suitable heat transfer fluid flows, or with a direct electric heating by Joule effect, or electric induction heating. Heating can also be achieved using microwaves. Heating by means of a heating jacket is particularly preferred.

If a heat transfer fluid is used, this can be a molten salt.

The residence time in a reactor where the entry of substantially plastic material is continuous (and, therefore, not of the “batch” type) is to be understood as the volume occupied by the non-gaseous phase divided by the volume flow rate of the substantially plastic material at the entrance to the pyrolysis reactor (calculable as mass flow rate divided by the density of said material at the entrance to the pyrolysis reactor). A batch reactor, on the other hand, it is to be understood as lasting the duration of the pyrolysis process.

In the pyrolysis process of the present invention, said residence time is preferably at least 30 minutes, more preferably between 45 and 600 minutes, even more preferably between 60 and 400 minutes, even more preferably between 90 and 300 minutes and most preferably between 130 and 240 minutes.

According to a preferred method, the pyrolysis vapours produced from the pyrolysis reactor they are subsequently passed through at least one condensation separator, so as to recover at least hydrocarbons that are liquid at 25° C. (as defined in the present invention).

The term separator by condensation means any equipment which receives a fluid in the gaseous state and is capable of removing sufficient heat from said fluid so as to generate at least a part of fluid in the liquid state. Examples of equipment are coil condensers inside which a heat transfer fluid flows capable of removing the heat from the fluid in the gaseous state being processed.

Other methods can also be used to subtract heat. For example, alternatively, or in combination, the condensation separator can be fitted with a jacket in which said heat-carrying fluid capable of subtracting the heat flows.

Advantageously, the flooded condenser can also be used, in which the condenser is partially flooded by the liquid phase produced and the condensing power of which is adjusted by varying the height of said liquid phase, as only the coil that is not flooded is able to absorb calories from the steam to be condensed. This therefore allows for an effective regulation of the capacitor power.

Alternatively, the condensation separator can consist of a distillation column. In this case, the condensed fluid originates in the column condenser and the condensed liquid flows back by gravity or by pumping into the column, condensing the vapours that are inside the column. Using a distillation column-type condensation separator, also results in a better fractionation of the vapours at the inlet, i.e., the separation between higher boiling components that are condensed and lower boiling components that remain in the vapour phase, as each equilibrium stage allows for an enrichment of the liquid phase of heavy components and an enrichment of the gaseous phase of light components. In addition, the condensed liquid that falls inside the column carries out a lavage of the vapours inside the distillation column. This has the result of retaining any solid particulate present in the incoming vapours, which ends up being collected in the liquid phase.

Several condensation separators can be used, preferably in series. Preferably, there are three condensation separators in series.

Said at least one condensation separator can work at a pressure substantially corresponding to that of the pyrolysis reactor or at a different pressure, for example, substantially atmospheric pressure, if the reactor operates under pressure. Any technique known in the art can be used to maintain the pressure in the pyrolysis reactor at a defined value. For example, according to a first method, the pressure can be maintained at a defined value by adjusting the heat extracted from the condensation separator located downstream of the reactor and in fluid connection therewith. Alternatively, according to a second method, the pressure can be adjusted using a controllable pressure drop device located downstream of the pyrolysis reactor and/or downstream of said at least one condensation separator, or, according to a third method, by feeding an auxiliary gas (such as nitrogen, for example). These methods can be combined if necessary.

Non-condensed gases, including any auxiliary gas possibly used for pressurisation, can be sent to a thermo-oxidation system before being released into the atmosphere.

The pressure in the reactor is preferably kept within an interval of between atmospheric pressure and 13 bara. More preferably, said pressure is kept within a range of between 1.1 and 8 bara. Even more preferably, said pressure is kept within a range of between 1.5 and 6 bara. Most preferably, said pressure is kept within an interval of between 2.5 and 4 bara.

The pressure in the reactor can be measured according to any method known in the art. For example, pressure transducers can be used, placed inside the reactor. Alternatively, according to a preferred method in the case, inert gases, such as nitrogen, are used for the initial pressurisation of the reactor. The pressure sensor can be advantageously placed inside the injection duct of said inert gases, even more preferably towards the entrance to the reactor.

Advantageously, the assessment of the property “Px” of said hydrocarbon liquid by means of said at least one measurement of the spectrum “Ax” is used to regulate at least one parameter “Ox” of the pyrolysis process.

Said at least one parameter “Ox” is preferably at least one of the following parameters: the pyrolysis pressure, the pyrolysis temperature, the residence time of the substantially plastic material in the pyrolysis reactor, the flow rate of the substantially plastic material in the pyrolysis reactor, and the ratio between the flow rates between more than one substantially plastic material fed into the pyrolysis reactor. This latter parameter is particularly useful, where there are recycled plastic materials of different origin or composition. It is therefore possible to obtain a pyrolysis oil of constant quality by having the controller dynamically and automatically regulate the ratio between the various power supplies so that the property “Px” on the pyrolysis oil produced still remains within the given target.

Said at least one parameter “Ox” is even more preferably at least one of the following parameters: the pyrolysis pressure, the pyrolysis temperature and the residence time of the substantially plastic material in the pyrolysis reactor. Even more preferably, said at least one parameter “Ox” is the pyrolysis pressure.

According to a first method, herein defined as “feedforward regulation”, the set point of said at least one parameter “Ox” is calculated based on the assessment of said at least one property “Px” and, specifically, the determination of the value of said property “Px”.

Said calculation can advantageously be a simple expression. If there is more than one at least one property “Px”, said expression for the calculation of at least one parameter “Ox” can advantageously include more than one property “Px”.

The adjustment of the process parameter “Ox” can be carried out by any means known in the art, for example, by means of a controller capable of reading said “Ox” value, comparing it with the set point and acting on at least one parameter of at least one system element (such as those already described above) in order to bring the difference between said two values to zero. To this end, any process controller can be used, such as a PID controller, fuzzy logic, particle swarm optimisation (PSO) or neural networks, or combinations of these, such as an integrated PID controller with fuzzy logic controller.

Preferably, said adjustment is carried out with a PID algorithm (proportional, integrative, derivative), in positional (position PID) or velocity (velocity PID) form.

According to a second, more preferred, method, herein defined as “feedback regulation”, the parameter “Ox” is dynamically adjusted so that the property “Px” reaches the target value or range. In this method, said property “Px” is therefore adjusted, in feedback, on the process parameter “Ox”. This feedback can be direct or in cascade. According to direct feedback, said regulator acts in feedback directly on the device, which has the effect of changing the process parameter “Ox”. According to the cascade regulation, the feedback of the regulator of the property “Px” acts by varying the set point of the property “Px” of a second regulator, which is the regulator of the process parameter “Ox” and which acts on said device which has the effect of changing the process parameter “Ox”.

Depending on the process parameter “Ox” and the property “Px”, the action can be direct (i.e., concordant) or inverse (i.e., discordant). In the case of direct action, an increase in “Ox” corresponds to an increase in “Px”, whilst, in the reverse case, an increase in “Ox” corresponds to a decrease in “Px” and vice versa. If it is not known in advance whether the action is direct or inverse, it suffices to carry out a preliminary test: if the action set on the controller is set in the wrong direction, the regulator quickly diverges, as the corrective action increases rather than decreases the error. In this case it will therefore suffice to reverse the action.

If “Ox” is the pressure of the reactor, said device, which has the effect of changing the process parameter “Ox” may be one or more of the disclosed devices which serve to control the pressure in the reactor. These include, for example, said controllable pressure drop device located downstream of the pyrolysis reactor and/or downstream of said at least one condensation separator, or the valve that adjusts the flow rate of the auxiliary gas or fluid in the condensation separator jacket.

If, on the other hand, “Ox” is the temperature in the pyrolysis reactor, said device which has the effect of changing the process parameter “Ox” can be a device that regulates the flow rate of the heat-carrying fluid in said reactor jacket, or the device that regulates the temperature of said heat-carrying fluid, or, in the case of electric or microwave heating, the device that regulates its power.

Preferably, said property “Px” is the refractive index “RI” and/or the viscosity “VI” of the pyrolysis oil produced by the process of the present invention.

In the event that said property “Px” is the refractive index “RI” of the pyrolysis oil, according to the “feedback” regulation mode described above, the target value of the property “Px” (i.e., the refractive index “RI”) is set to a value of between 1.415 and 1.465 nD, preferably between 1.42 and 1.455, even more preferably between 1.425 and 1.45.

In the event that said property “Px” is the viscosity “VI” of the pyrolysis oil, according to the feedback regulation mode described above, the target value of the property “Px” (i.e., the viscosity “VI”) is set to a value of between 0.7 and 1.2 cP, preferably between 0.8 and 1.1 cP, even more preferably between 0.85 and 1.05 cP.

Generally, the method that allows the best results to be achieved is that according to which said property “Px” is the refractive index and said process parameter “Ox” is the pressure of the reactor.

Preferably, the pyrolysis oil obtained from the process of the present invention is a compound that comprises hydrocarbons in an amount greater than 90% by weight with respect to the total weight of the compound.

Preferably, the pyrolysis oil obtained from the process of the present invention has a tetrahydrofuran (THF) content equal to no more than 1% by weight, preferably between 0.01% and 0.25% by weight, even more preferably between 0.07 and 0.19% by weight, with respect to the total weight of the compound.

Preferably, the liquid product at 25° C. condensed by said pyrolysis vapours (i.e., the pyrolysis oil) obtained by the present invention has a C5-C12 fraction equal to at least 35% and, simultaneously, a C21-and-higher fraction (hereinafter referred to as: “C21+”) equal to at most 3.5%.

Preferably, the yield in C5-C12 obtained by the present invention is at least 30%, whilst the yield in C21 and above is at most 3%.

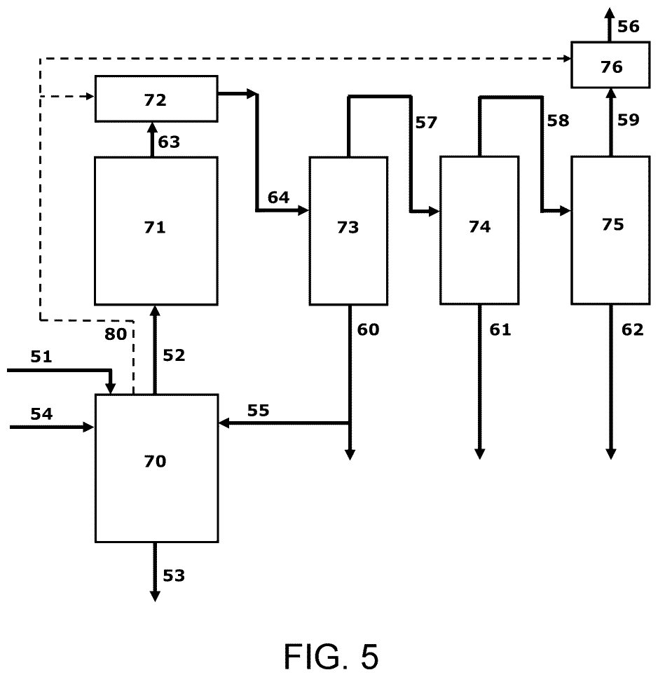

FIG. 5 is a diagram of an example of a device for the process of the invention, wherein the following can be seen:
a reactor (70) for the pyrolysis of substantially plastic material (54) which produces pyrolysis vapours (52) and a solid residue (53) and which optionally receives an auxiliary gaseous fluid (51) to help maintain the pressure inside the reactor;
a second reactor (71) which transforms the pyrolysis vapours (52) leaving the pyrolysis reactor (70);
a first pressure control device (72), such as, for example, a valve, which acts in feedback with respect to the pressure value (80) measured in the pyrolysis reactor (70);
a first condenser (73) the condensates (60) of which are partially returned (55) to the pyrolysis reactor (70);
a second condenser (74) which receives the vapours (57) leaving the first condenser (73) producing a second condensate (61) and the vapours (58);
a third condenser (75) which receives the vapours (58) from the second condenser (74) producing a third condensate (62) and non-condensed vapours or the residual gas (59);
a second device for controlling the pressure (76) in feedback with respect to the pressure value (80) measured in the pyrolysis reactor (70), for example, a valve that restricts the passage section of the residual gas leaving the condenser (59) before sending the residual gas (56) to the unit capable of receiving it.

One aspect of the present invention is an apparatus for the pyrolysis of substantially plastic material to obtain at least hydrocarbons that are liquid at 25° C. comprising:
at least one reactor for the pyrolysis of substantially plastic material;
at least one condensation separator which receives the vapours from said at least one pyrolysis reactor and which carries out an at least partial condensation thereof;
at least one device that performs the measurement “Ax” of the spectrum in transmission, reflection or transflexion of the liquid condensed from said effluent in the gaseous state;
at least one system that assesses at least one property “Px” of the liquid condensed from said effluent in the gaseous state by at least said measurement “Ax”; adjusting at least one process parameter “Ox” according to said assessment of at least one property “Px”.

According to one embodiment of the present process, the gaseous effluent produced in step c) can be further treated in a second reactor in a dedicated step c2) before carrying out the partial or total condensation referred to in step d). Preferably, this further treatment of step c2) involves bringing said effluent to a temperature of between 40° and 650° C., preferably between 440° C. and 550° C., even more preferably between 460° C. and 530° C. and keeping said effluent in said temperature range for a time equal to at least 10 seconds, preferably between 30 seconds and 6 minutes, even more preferably between 1 and 4 minutes.

Preferably, step c2) is carried out in the presence of a solid catalyst in contact with said effluent in the gaseous state. Even more preferably, said effluent in the gaseous state is in relative movement with respect to said solid catalyst in contact with said effluent in the gaseous state and said relative movement is at a speed equal to at least 10 m/s, more preferably between 20 and 300 m/s.

### Examples of Embodiment of the Pressure Control According to the Invention

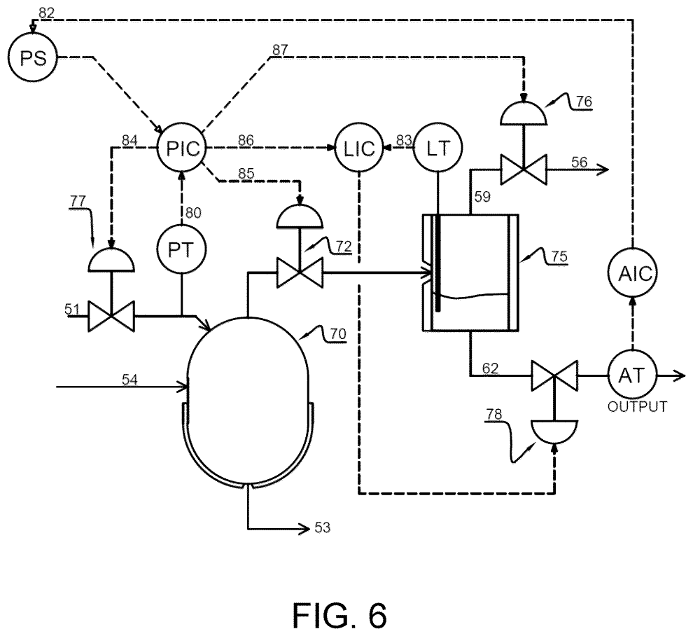

FIG. 6 shows some examples of embodiment of the pressure control according to the invention, where a flood-type condensation separator (75) is shown fitted with level sensor (LT) and level adjustment system by modulating the opening of the valve (78) on the condensates outlet (62).

With reference to said figure, the pyrolysis reactor (70) receives, at its inlet, the substantially plastic material (54) and, optionally, an auxiliary gaseous fluid (51), producing a solid residue (53) and pyrolysis vapours directed towards the at least one condensation separator (75). The optional adjustment valve (72), receives the pyrolysis vapours from said pyrolysis reactor (70) and sends them to a condensation separator (75). The opening adjustment is given by the signal (85).

The condensation separator (75), in FIG. 6, is a flood condenser: the condensed fluid floods the lower part of the condenser and condensation is carried out by passing a heat transfer fluid, which is colder than the pyrolysis vapours, into a jacket or coil positioned so that, depending on the level of the condensed liquid, the part of the jacket in contact with the vapours to be condensed varies (for example, by applying the jacket on the side wall of said condenser).

The optional adjustment valve (76) adjusts the pressure by restricting the passage section of the residual gas (59) before sending it (56) to the receiving unit.

The optional adjustment valve (78) adjusts the flow of the condensed fluid (62) and, therefore, the flooding level of the flooding condenser (75).

The optional adjustment valve (77) adjusts the flow rate of the auxiliary gaseous fluid entering the pyrolysis reactor (70).

The level controller (LIC) reads the level signal (83) of the flood condenser (75) measured by the level sensor (LT) and adjusts, in feedback, the opening of the valve (78) to ensure that the level (83) corresponds to the set point indication (86) received from the PIC controller. It should be noted that said set point indication (86) is equal to 0 for 100% level (i.e., maximum flooding=minimum condensing power) and 100 for 0% level (i.e., empty condenser=maximum condensing power).

The opening indication (87) sent to the valve (76) is 0 for closed valve and 100 for fully open valve.

On the other hand, the opening indication (84) sent to the valve (77) operates in reverse mode, because the valve (77) must open to increase the pressure of the reactor (80) and close to decrease it.

The pressure signal of the pyrolysis reactor (80) may be the result of the processing of multiple pressure transducers; furthermore, as shown in the figure, it can be detected on a clean fluid sent to the pyrolysis reactor, near the outlet towards said reactor, so that the membrane of the transducer remains clean. The figure shows the case in which said pressure signal is taken on the conduit carrying the auxiliary gaseous fluid (51) to the pyrolysis reactor.

The pressure set point of the pyrolysis reactor (PS) can be set local, or provided manually, for example by setting the value on the control panel of the plant, or it can be set remotely, or come from an external setting signal.

Said external signal is a set point (82) calculated by the feedback controller (AIC) which adjusts said set point (82) so that a parameter representative of the quality of the product in the liquid state obtained after condensation (62), measured by the analyser online or offline (AT OUTPUT), reach the target value.

The pressure controller (PIC) reads said pressure signal (80) and compares it with the set point (PS) and acts individually on one of the regulation devices (84, 85, 86, 87) or in combination, for example, using a PID algorithm (proportional, integrative, derivative) in feedback, in order to minimise the error between the signal read (80) and the set point (PS). An example of embodiment of said combination is obtained by using the adjustment devices (86) and (87) in split range mode.

### Methods of Gas-Chromatographic Analysis on Pyrolysis Oil Samples

The pyrolysis oil samples were characterised by gas chromatographic analysis. The qualitative identification of the compounds was preliminarily carried out using a coupled gas chromatography-mass spectrometry (GC-MS) technique, whilst the quantification thereof was carried out by gas chromatography with flame ionisation detector (GC-FID).

Below are the instrumental parameters used for the GC-FID analyses:
GC: Agilent HP 7890 B, fitted with MPS autosampler Gerstel
Column: HP-PONA Agilent Technologies J&W—50 m-0.2 mm-0.5 μm,
Carrier (H2): 1.1 mL/min constant flow
Injector: 320° C., split 255:1, 3 mm liner (Ultra Inert) with glass wool
Detector: 360° C.
Oven: Column temperature programme: 20° C. 5 min, at 2° C./min up to 70° C. for 5 min, at 2° C./min at 160° C. for 5 min, at 2° C./min at 320° C. for 30 min (Run time: 195 min).

The samples are analysed as such by attributing an arbitrary response factor equal to one for all the compounds; the concentrations obtained are then normalised to 100%.

### Methods of Gas-Chromatographic Analysis on Wax Samples

The term “wax” refers to the fraction left on the bottom after the ultracentrifugation of the pyrolysis oil, as described below.

This fraction is analysed differently in order to also identify compounds with a high molecular weight.

In fact, these compounds could plausibly not be eluted and analysed during gas chromatographic analyses.

Before taking the sample for GPC analysis, the pyrolysis oils contained in Schott bottles were heated to 50° C. to homogenise the contents (in some cases characterised by deposits and/or stratification of waxy compounds at room temperature or cooled). A few mg of sample in 1,2,4-trichlorobenzene (Baker) were melted whilst hot (one hour of dissolution at 150° C.) added with 10 μL of n-heptane (internal marker) in order to obtain a concentration of approximately 1.8 mg/mL.

The analyses were carried out on a chromatographic device comprising the following:
high-temperature GPC-IR Polymer Char
bench of 3 TSK gel HT2 columns with dimensional 13 μm and pre-column
high-temperature IR5 infrared detector that provides an absorbance signal proportional to the quantity of methyl and methylene groups.

The experimental conditions used are as follows:
eluent: 1,2,4 TCB stabilised with BHT
flow: 1 mL/min
temperature: pump at 25° C., injector at 150° C., columns at 150° C., detector at 150° C.
injection volume: 200 microlitres
internal standard: n-heptane.

### Method of Gas-Chromatographic Analysis on Pyrolysis Gas

The pyrolysis gaseous effluent samples were sampled in 500 mL Swagelok cylinders of the DOT type (i.e., regulated by the U.S. Department of Transportation—DOT) in stainless steel type 304L, coated with PTFE to make the internal surface inert. The instrumentation used is an Agilent 490 ρGC equipped with 3 modules in parallel, each of which determines only certain types of compounds. Specifically:
Module 1: 10 m MS 5 Å with heated injector and backflush
Module 2: 10 m PPQ with unheated injector
Module 3: 10 m CpSil-5CB with heated injector

Below are the instrumental parameters used for the various modules:
Module 1: T injector: 110° C., Backflush: 30 s, t injection: 100 ms, T column: 45° C., Carrier gas pressure: 80 kPa, Carrier gas: Argon (fundamental for hydrogen analysis).
Module 2: t injection: 15 ms, T column: 70° C., Carrier gas pressure: 180 kPa, Carrier gas: Helium.
Module 3: T injector: 110° C., t injection: 20 ms, T column: 70° C., Carrier gas pressure: 230 kPa, Carrier gas: helium.

Each module analyses only some specific compounds:
Module 1: Hydrogen, oxygen, nitrogen, methane, CO.
Module 2: CO2, ethylene, ethane, propylene, propane, propadiene, propyne, i-butane, i-butene, 1-butene, 1,3-butadiene, n-butane, trans-2-butene, cis-2-butene.
Module 3: 1-buten-3-ino, 1,2-butadiene, i-pentane, 1,4-pentadiene, 1-pentene, n-pentane, 2-methyl-2-butene, 1,3-pentadiene, cyclopentene, n-hexane, methyl-1,3-cyclopentadiene, benzene, 3-ethylcyclopentene, methylcyclohexane, toluene, ethylbenzene, xylene.

The quantification is carried out by means of a calibration line with an external standard, consisting of two calibration cylinders with the following composition:
Cylinder 1: PENTENE-2 (trans)=0.1% mol; PENTENE-2 (cis)=0.1% mol; PENTENE-1=0.1% mol; PENTANE-n=0.25% mol; METHYL-2 BUTENE-2=0.2% mol; ISOPENTANE=0.5% mol; HEXANE-n=0.1% mol; PROPYLENE=20% mol; PROPANE=0.5% mol; PROPADIENE=0.5% mol; METHANE=20% mol; ISOBUTENE=1% mol; ISOBUTANE=0.5% mol; HYDROGEN=15% mol; ETHYLENE=30% mol; ETHANE=3% mol; CARBON MONOXIDE=1% mol; CARBON DIOXIDE=0.5% mol; BUTENE-1=1% mol; BUTENE-2 (trans)=0.5% mol; BUTENE-2 (cis)=0.5% mol; BUTANE-n=0.5% mol; BUTADIENE-1,3=1.5% mol; ACETYLENE=0.5% mol; Complement to 100%: NITROGEN. Cylinder volume [litres]: 40; Charging pressure [bar]: 6.29; Cylinder type: Aluminium.
Cylinder 2: BENZENE=0.0302% mol; TOLUENE=0.0323% mol; METHYL CYCLOHEXANE=0.0674% mol; STYRENE=0.0334% mol; ETHYLBENZENE=0.0339% mol; Complement to 100%: HELIUM. Cylinder volume [litres]: 5; Charging pressure [bar]: 13.9; Cylinder type: Aluminium.

The following compounds are not present in the calibration cylinders. Therefore, the calibration was used of compounds sufficiently similar thereto, which have very similar response factors (the difference in this case is negligible):

| Compound: | Calibrated with: |
|---|---|
| propyne | Propadiene |
| 1-buten-3-ino | 1,3-butadiene |
| 1,2-butadiene | 1,3-butadiene |
| 1,3-pentadiene | 1,3-butadiene |
| 1,4-pentadiene | 1,3-butadiene |
| Cyclopentene | 1-pentene |
| Methyl-1,3-cyclopentadiene | 1-pentene |
| 3-methylcyclopentene | 1-pentene |

### Method of Thermogravimetric Analysis (TGA) on Solid Residue (CHAR)

The TGA analysis was performed on a TA instrument Instrument model Q 500. The temperature calibration was carried out using the Curie Point of Alumel and Nickel samples, whilst the weight calibration was carried out using certified weights provided by the TA Instrument together with the analyser. The sample as it is, weighed by quantities of between 20-30 mg in a stainless steel sample holder, was placed together with the sample holder on the platinum crucible of the TGA analyser. The use of the stainless steel sample holder facilitates the isolation and recovery of the final residue (ashes) whilst preserving the integrity of the platinum crucible. The sample is subjected to an analytical procedure in three steps:
1st step (pyrolysis in nitrogen atmosphere): starting from an initial temperature of 40° C., the sample is heated at a controlled rate (v=10° C./min) up to 800° C.;
2nd step (cooling in nitrogen atmosphere): starting from an initial temperature of 800° C., the sample is cooled at a controlled rate (v=20° C./min) up to 400° C.;
3rd step (thermo-oxidation in air atmosphere): starting from a temperature of 400° C., the sample resulting from pyrolysis (step 1) is subjected to heating at a controlled rate (v=20° C./min) up to 850° C.

The integrations were performed using Universal software (TA Instruments), determining:
STEP 1: the weight loss at various temperatures after determining the temperature corresponding to the maximum peak of the derivative of the weight loss with respect to the temperature and the residue at 800° C.
STEP 3: the loss in weight at various temperatures subject to the determination of the temperature corresponding to the maximum of the peak of the derivative of the weight loss with respect to the temperature and the residue at 850° C. For STEP 3, the weight losses correspond to one or more carbonaceous species different in allotropic state or in particle size.

### Method of Determining the Ash (Inorganic Residue) on Substantially Plastic Materialo

20 grams of substantially plastic material are weighed on a crucible and inserted into an oven (Heraeus model K1253, Tmax 1250° C.) maintained in a nitrogen supply. The temperature is brought to 400° C. at 5° C./min ramp and maintained at 400° C. for an additional hour. Air is then fed instead of nitrogen and the temperature is gradually brought up to 850° C. again in a 5° C./min ramp and kept at 850° C. for another hour, then the oven is turned off and left to cool for approximately 12 hours.

The remaining material is called ash and is weighed. The percentage of ash was calculated as the weight of said residue with respect to the amount of material of the substantially plastic material initially weighed (20 grams).

Some illustrated but non-limiting examples of the present invention follow.

### EXAMPLES

### Raw Material

It was considered appropriate to use virgin raw material, the composition of which is therefore known and constant, thus also facilitating the repeatability of the invention. By preparing appropriate mixes of the raw material, it was therefore possible to assess the effect on pyrolysis due to the sole variation thereof.

The virgin materials used were the following:

| Polymer | Acronym | Degree | Manufacturer |
|---|---|---|---|
| Low-density | LDPE | Riblene ® | Versalis |
| polyethylene | | FC20 | |
| Low-density | LLDPE | Flexirene ® | Versalis |
| linear polyethylene | | CL10 | |
| High-density | HDPE | Eraclene ® | Versalis |
| polyethylene | | BC82 | |
| Polypropylene | PP | Isplen ® | Repsol |
| | | PP040 | |
| Polystyrene | PS | Edistir ® | Versalis |
| | | N3782 | |
| Polyethylene | PET | Monflakes ® | Montello |
| terephthalate | | R-PET | |
| Cellulose | CELL | C6288 | Sigma- |
| | | | Aldrich |
| Polyvinyl chloride | PVC | S3160 | Vinnolit |

The polyethylene granules were mixed in the following ratio: 5.7% of HDPE Eraclene BC82, 34.3% of LLDPE Flexirene CL10 and 60% of Riblene FC20. This mixture is therefore the “PE” material subsequently used.

The following table shows the atomic composition (percentages by weight) of the materials used.

| | | MATERIALS (acronyms) | | | | | |
|---|---|---|---|---|---|---|---|
| | | PE | PP | PS | PET | CELL | PVC |
| Atom | H | 14.3% | 14.3% | 7.7% | 4.2% | 6.2% | 4.8% |
| | C | 85.7% | 85.7% | 92.3% | 62.5% | 44.4% | 38.7% |
| | N | 0.0% | 0.0% | 0.0% | 0.0% | 0.0% | 0.0% |
| | O | 0.0% | 0.0% | 0.0% | 33.3% | 49.4% | 0.0% |
| | Cl | 0.0% | 0.0% | 0.0% | 0.0% | 0.0% | 56.5% |

The following mixtures were prepared using the listed raw materials (parts by weight):

COMPOUND

| | PATA | PATB |
|---|---|---|
| PE | 70.00 | 45.60 |
| PP | 29.00 | 20.00 |
| PS | 1.00 | 27.00 |
| PET | 0.00 | 5.40 |
| CELL | 0.00 | 1.00 |
| PVC | 0.00 | 1.00 |

In addition, 4 batches of recycled materials were used, which, together, with said PATA and PATB mixtures were analysed to determine the index of the hydrogen-to-carbon ratio (H/C index) and the Carbon Index (C.I.). These two indices are calculated by carrying out the elementary analysis and by calculating said indices on the basis of the previously disclosed formulas. The recycled materials were also analysed using thermogravimetric analysis in order to determine the final inorganic residue (ash).

The results were as follows:

| | MATERIALS | | | | | |
|---|---|---|---|---|---|---|
| | B01 | B02 | B03 | B04 | PATA | PATB |
| H/C index | 95.1 | 90.6 | 87.7 | 70.3 | 99.5 | 74.5 |
| C.I. Carbon | 82.9 | 79.6 | 82.5 | 78.8 | 85.8 | 78.0 |
| Index | | | | | | |
| Residue [%] | 2.9 | 4.4 | 4.8 | 7.0 | — | — |

### Examples of Preparation of the Granulated Polymer Mixture

The mixtures were prepared as per the table of compositions described above (PATA, PATB).

In a Coperion ZSK 26 twin-screw extruder, the mixtures thus prepared were melted at 250° C., mixed with mixing elements present in the extruder screws and passed through an extrusion die. The overall residence time in the extrusion was less than one minute. The mixture of polymers thus obtained was then cooled in a liquid bath and granulated into granules with a diameter and length of approximately 3 mm. In this way, the mixtures of the granulated polymers PATA and PATB were produced.

### Device for Feeding Substantially Plastic Material at Least Partially in the Molten State

The device in question consists of a ZSK 26 rotating twin-screw extruder with a screw length to diameter ratio equal to L/D=32. The extruder is equipped with the following:
Feeding section, fitted with a hopper and a screw profile with transport elements;
melting and mixing section, in which kneading and mixing elements are used;
degassing section, where the pressure of the polymer spindle is reduced, thus reducing the diameter of the screw core and an opening is made in the cylinder, connected to a vacuum pump, for the suction of any gases produced;
Pressurisation section, where the diameter of the core of the screw is increased;
The extruder is equipped with a heating and cooling control system to regulate the temperature of the barrel in the sections of the extruder specified above;
The speed of the extruder screw was kept high enough to ensure that the extruder hopper was kept empty.

Two gravimetric dosers allow for the dosage of a given flow rate. The PATA mixture was fed into the first dispenser, whilst the PATB mixture was fed into the second metering unit.

In the extruder heating and cooling control system, all the temperature set points of the extruder barrel have been set at 200° C.

### Pyrolysis Device Used for the Pyrolysis Examples (“Device 1”)

The pyrolysis device used for the pyrolysis Examples of the present invention comprises the following:
a thermostated reactor, fitted with a flange for loading materials, a dip tube for the inerting gas (nitrogen) inlet, a nozzle for connection to a possible extruder for the entry of substantially plastic material, a nozzle for the exit of vapours and a nozzle for each of the thermocouples for measuring the temperature and pressure measurement, plus two nozzles for level measurement by measuring the differential pressure between the two nozzles (“DP-cell”);
a stirring system for said reactor, fitted with an anchor agitator, low rotation speed (tip velocity approx. 0.1 m/s) and breakwater;
a flow meter fitted with a fine adjustment valve to regulate the inerting gas inlet flow into the reactor;
a pressure transducer located on the head of the reactor, plus a local pressure gauge, which read the pressure of the gases inside the reactor;
three thermocouples for measuring the actual temperature located in the lower part of the reactor (one for control and the others for reading and checking);
a level meter by means of “DP-cell”;
a reactor temperature regulation system that reads the temperature value of one of the three thermocouples and acts in feedback on the thermostating system, whose control parameters have been suitably calibrated to ensure high thermal stability (temperature fluctuations below 5° C.);
a condenser for the condensation of the vapours leaving the reactor, kept at −10° C. by means of a refrigerant fluid made to flow by a refrigeration unit at a controlled temperature;
a regulating valve interposed between said reactor and said condenser, hereinafter referred to as a pressure regulating valve. In fact, depending on the valve stroke with the same flow rate of the pyrolysis vapours produced, the pressure drops vary and, therefore, the devices being substantially downstream at ambient pressure, the pressure of the pyrolysis reactor also varies;
a hermetically connected expandable balloon at the upper outlet of said condenser designed to collect the gaseous fraction that is not condensed;
a hermetically connected receiving container at the lower output of said condenser designed to collect the condensed fraction and, therefore, in the liquid state, with the vents connected to said upper output of the condenser;
a valve for the interception of incoming nitrogen;
a valve for the interception of the liquid product leaving the condenser, before the hermetic connection with the receiving container;
a valve for the interception of the gaseous product leaving the condenser, before the hermetic connection with the expandable flask;
device for feeding the substantially plastic material at least partially in the melted state to the pyrolysis reactor as described above;
2 gravimetric dosers for dosing the granulated polymeric mixture in the hopper of said twin-screw extruder for dosing the granulated polymeric mixture in the reactor.

The probe for the detection of the transmission spectrum used in these examples is the Hellma Excalibur HD FPT25 immersion probe in Hastelloy C-22 and with a sapphire window.

The probe has a diameter of 25 mm, an optical path of 5 mm and with maximum operating conditions of 27 bar at 290° C.

The probe is inserted in a well located in the reactor vapour outlet pipeline, immediately downstream of said pressure regulating valve. The position of the probe in the well has a depression such that the window always remains flooded with condensed hydrocarbon liquid. Condensation is obtained by removing the insulation in the section of pipe preceding the probe.

A reduced diameter pipe connected to said well, in correspondence with the probe, allows for the withdrawal of the hydrocarbon liquid just read by the probe and the emptying of the well at the end of the experiment and between one test and the next, in order to ensure complete replacement of the condensed. Said sampling is used to collect the sample materials during the probe calibration phase, but is not used in the production phase.

Said probe is connected, using optical fibres with a diameter of 600 μm, to a Fourier transform spectrometer (FT-NIR) Bruker Matrix-F model, both for light emission and for detection. Said spectrometer is fitted with an InGaAs detector, spectral range of 12800-4000 cm⁻¹ and spectral resolution of 2 cm⁻¹. It is also fitted with an industrial PC connected via Ethernet, plus Modbus interface for communication with the control system (DCS, PLC) of the pyrolysis plant. In production mode, the spectrometer continuously. Performs the measurements of the spectrum “Ax”, from which, through the previously calculated calibration curve “Cx”, the value of “Px” is determined.

Direct feedback control is set by means of two controllers with PID algorithm (proportional, integrative, derivative), or one for each of the variables “Px”, refractive index “RI” and viscosity “VI”. The process parameter “Ox” chosen for the feedback is pressure. The device on which the controller acts is the pressure regulating valve. In “man” mode, the controller acts directly on the valve actuator position (the operating point “OP”=0 valve closed, “OP”=100 valve 100% open), whilst in “auto”, the value must be set of the desired parameter “Px” and the regulator acts on the position of the actuator (changing the operating point “OP”) so that the measured value of “Px” reaches the set value.

A selector for the output of the PID controller relative to the “RI” refractive index, or that relating to the viscosity “VI” to be sent, in order to select with respect to which variable to perform the feedback.

The latency time between said acquisition of the spectrum “Ax” and the action on the stem (i.e., the action towards the pressure process parameter “Ox”), which therefore includes: the spectrum acquisition time, the assessment of “Px” and the use of this value for the calculation of the next position of the actuator, is less than one minute. In this regard, it should be noted that the latency time is independent of the integral and derivative time of the PID controller: in fact, they act on the adjustment speed, whilst latency time is a measurement of the action delay, which never acts on the instantaneous value of the property “Px”, but always on a delayed value.

### Calibration Examples

Determination of the Calibration Curve “Cx”

“Device 1” was used to produce the pyrolysis oil samples used as sample materials. For this purpose, an attempt was made to make sample materials as varied as possible in order to obtain a robust calibration curve “Cx” (and, therefore, capable of working also for dissimilar materials). The 4 recycled materials B01, B02, B03 and B04 the two materials obtained from mixtures of virgin materials PATA and PATB were selected as mixtures. Pyrolysis was carried out at 430° C., varying the pressure and residence time and taking the sample material to carry out the primary analysis immediately after the spectrum thereof was measured using the probe.

The calibration curves were determined according to the “rolling” mode described above and selecting 5 sample materials for verification and the remaining sample materials as calibration samples for multivariate regression. The second round was carried out by selecting 5 other sample materials (different from the first sample materials) for verification and the remaining ones as calibration samples for multivariate regression. This was done in the same way until all sample materials were used at least once as test samples. This procedure was performed both for the determination of the calibration curve “Cx” of the viscosity “VI” and for that of the refractive index “RI”.

To determine the “Cx” on the refractive index (“RI”), 27 sample materials were used, in 6 rounds, where in the final round, only two sample materials were used (total samples for verification: 5+5+5+5+5+2=27). For the determination of the “Cx” on viscosity (“VI”) 23 sample materials were used in 5 laps, where only 3 sample materials were used in the last lap (total samples for verification: 5+5+5+5+3=23).

A PLS (partial least squares) multivariate regression was applied.

The final calibration curve uses the values of the loadings, which is given by the average of the loadings identified according to the previously disclosed rotation method.

### Choice of Number of Components

The number of PLS components to be used in the model was assessed.

A small number of components reduces the accuracy of the model, whilst an excessive number of components poses the risk of overfitting, reducing the extrapolative and interpolative capacity of the model. Therefore, it is generally optimal to choose the number of components that minimise the error and where there are multiple values of the abscissa that maintain the minimum error, it is advantageous to select the value of the smallest abscissa.

FIG. 3 shows the result, which shows that the mean square error in prediction drops to low values already using the first 5 components (NC=5) for the viscosity calibration curve “Cx”. For the refractive index, the optimal value was instead found to be instead equal to 8 components. As can be seen from FIG. 3, both choices correspond to the value of the number of components which minimises the mean square error. In this case, for the number of components greater than the selected value, the quadratic error increases; however, if the trend had remained flat (i.e., minimum value reached and then maintained for higher abscissa values); however, it would have been preferable to select the smallest number of components that ensures said minimum mean square error.

### Accuracy of Prediction of Calibration Curves “Cx”

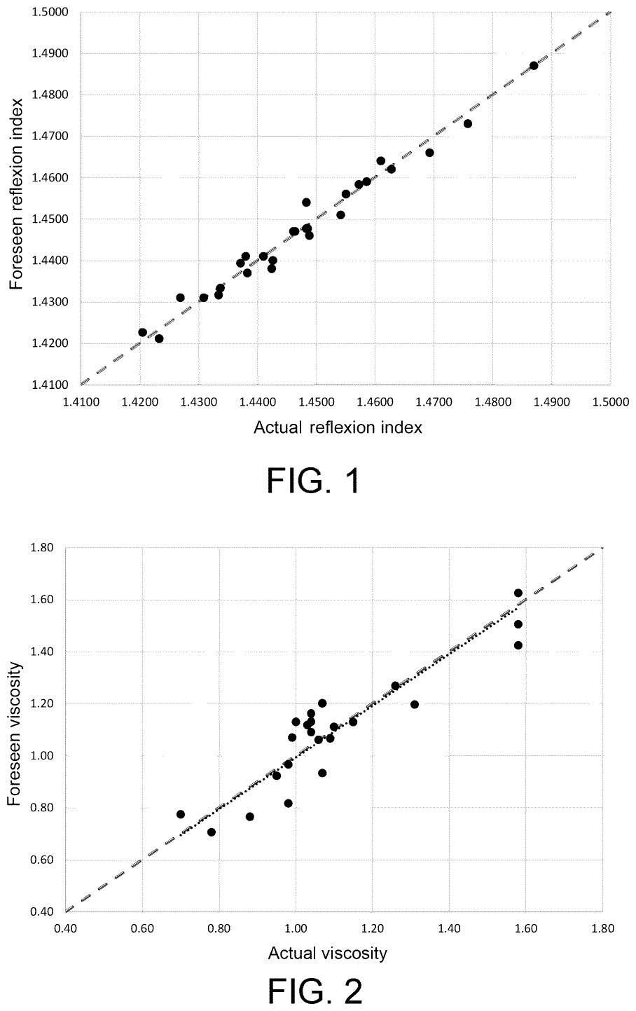

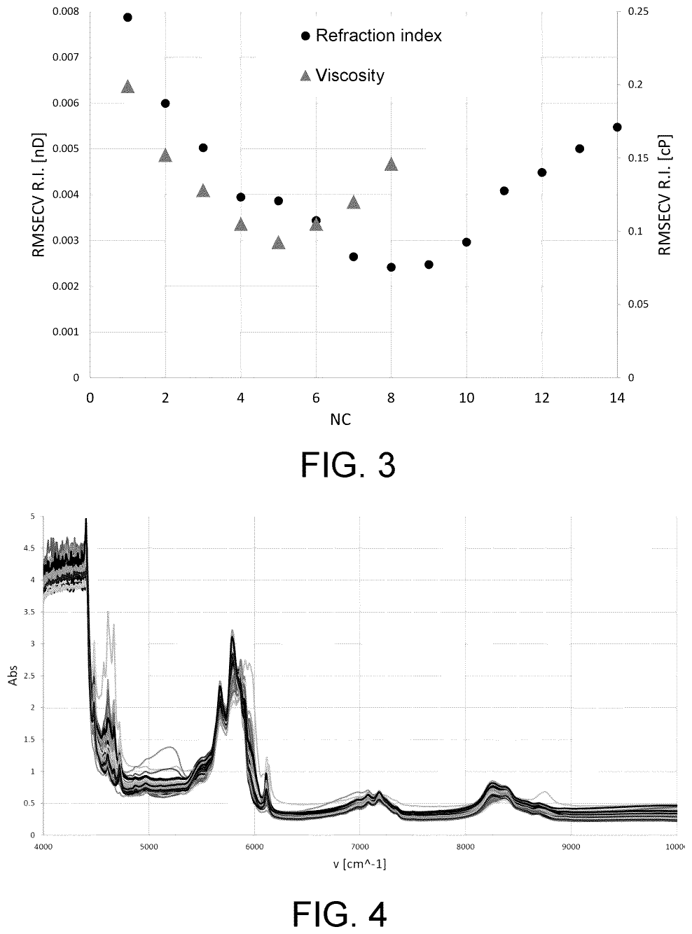

FIGS. 1 and 2 show, respectively, the refractive index “RI” and the viscosity “VI” calculated with said calibration curve, in comparison with the corresponding “true” values (i.e., determined on the basis of the primary analysis, with the methodologies and equipment described above). From these figures it is clear that the predictive ability and the good accuracy of the method disclosed in the present invention.

### Production Examples (Comparative and According to the Invention)

### Example 1

In the reactor of “Device 1” described above, already preheated for 6 hours at 430° C. and inerted with a flow of nitrogen, the “PATA” mixture was continuously fed by means of said gravimetric doser and said extruder. Initially, the pressure regulating valve selector was set with respect to the output of the refraction index regulator, but the latter regulator was set in “Man” and with the operating point “OP” at 100, in order to keep the valve open at 100%; therefore the reactor pressure was kept substantially at the atmospheric pressure level (approximately 1.1 bar).

The flow rate of the gravimetric doser was adjusted so that there was an initial filling of approximately ⅓ of the height of the reactor (determined by the level of the “DP-cell”), and then reduced it to keep said level substantially constant. In this way, the residence time, calculated as the ratio of the filled volume of the reactor and the volumetric flow rate of the polymer substantially in the molten state (calculated as the ratio between the mass flow rate of the gravimetric doser and the density of the substantially plastic material in the molten state), it was found to be approximately 6 hours.

The pyrolysis vapours that were produced in the reactor were then condensed by said condensation system, whilst the non-condensed vapours were recovered from the expandable flask. During the test, it was possible to change the expandable flask and the condensate collection capacity by means of said shut-off valves. The viscosity “VI” and the refractive index “RI” were continuously monitored by means of the measurement “Ax” of the spectrum of the pyrolysis oil, that is, the hydrocarbon liquid that passed in front of the spectrum meter.

It went on for 12 hours. The viscosity value “VI” thus obtained stabilised at approximately 1.10 cP, whilst the refractive index “RI” stabilized at approximately 1,445 nD.

The pyrolysis reaction and all the other process parameters were stable, i.e., without fluctuations and time shifts. The liquid and gaseous sample collected under these conditions was taken for analysis.

### Example 2

Example 1 was not repeated, but was then continued as follows: the pressure controller was set to “AUTO” and therefore the feedback with respect to the refractive index “RI” was activated. The target refractive index (“set point”) was set at 1.44 for approximately 2 hours, then at 1.435 for another 2 hours, then at 1.43 for another two hours and, lastly at 1.425 for a further 2 hours. The control was stable under all conditions and gradually led to partially closing the pressure regulating valve. In the final condition (RI=1.425), the pressure inside the reactor stabilized at approximately 5.5 bara. Viscosity VI, also assessed continuously using the same method, settled at approximately 0.89 cP.

Under all conditions, the refractive index value obtained stabilised and corresponded to the value set in the controller. The sample collected under these conditions was taken for analysis.

### Example 3

Example 2 was repeated, but then continued by verifying the stability of the feedback control with respect to the viscosity: for this purpose, the relative regulator was first set to “man”, with the OP at the value set by the refractive index PID regulator; then the signal selector was moved to the pressure control valve on the viscosity PID output. The target viscosity (“set point”) was set equal to 0.89 and then the controller was set to “auto”. The control was stable. The set point viscosity was then raised to 0.95, kept fixed for two hours, then brought to 1.04, held fixed for another two hours and finally brought to 1.1 cP and held fixed for another 2 hours. The pressure regulating valve was gradually opened.

Under all conditions, the obtained viscosity value stabilised and converged to the value set in the controller. The reactor pressure gradually dropped and substantially returned to atmospheric pressure.

### Reactor Reclamation:

The feeding of the mixture was then interrupted and the pyrolysis of the material remaining in the reactor was carried out, until exhaustion. It was then kept under nitrogen flow for another 6 hours whilst it was being cooled.

The reactor was then opened and it was seen that there were traces of fouling.

### Example 4

Example 1 was repeated, but continuously feeding the “PATB” mixture instead of the “PATA”.

The “VI” viscosity value was approximately 1.65 cP, whilst the “RI” refractive index was approximately 1,505 nD.

The sample collected under these conditions was taken for analysis.

### Example 5

Example 4 was repeated, but then continued as follows: the pressure controller was set to “AUTO” and in feedback with respect to the refractive index “RI”. The target refractive index (“set point”) was set at 1.505 for approximately 2 hours, then dropped to 1.49 for another 2 hours, recording a viscosity equal to approximately 1.58 cP and then to 1.48 for another two hours, recording a viscosity equal to approximately 1.52 cP. The adjustment was fairly stable but less precise than in Example 2.

It was therefore decided to take a sample for analysis and discontinue the test, still carrying out the reclamation as described for Example 3. After reclamation, it was found that the inside of the reactor showed widespread fouling. A cleaning procedure was then carried out by brushing and blowing.

### Example 6

Example 4 was repeated again, again using the “PATB” mixture but, this time, again with the selector set on the refractive index controller, the latter was immediately set to “AUTO” mode, setting, at the same time, the target refractive index (“set point”) to 1.44.

The pressure gradually increased to approximately 6.5 bara, stabilising at around this value. This value was maintained for approximately 12 hours, whilst, at the same time, verifying a good stability of all the parameters. The refractive index stabilised at around 1.44 nD, whilst the viscosity gradually decreased to approximately 0.95 cP. The feedback regulation with respect to the viscosity regulator was then tested again, setting the set point at 0.95 cP. The regulator was stable. The sample collected under these conditions was taken for analysis.

### Example 7

Example 6 was continued, setting the feedback, with respect to viscosity, at 0.88 cP. The pressure rose and then stabilised at approximately 7.5 bara. The refractive index, again measured by means of the correlation “Cx”, was brought to approximately 1.43 D. The regulator was stable. The sample collected under these conditions was taken for analysis.

The sample collected under these conditions was taken for analysis. The reactor was then reclaimed as indicated in Example 3. The reactor was then opened, and no presence of fouling was observed in it.

### Example 8

Example 1 was repeated, but continuously feeding the “B02” mixture of recycled material, instead of the “PATA” mixture.

The selector was set on the refractive index controller and the latter was immediately set to “AUTO” mode, whilst setting the target refractive index (“set point”) to 1.44. The pressure gradually increased to approximately 5.5 bara, stabilising at around this value. The system was kept under regulation for approximately 12 hours, without showing any problem. The reactor was then cleaned as specified in Example 3. The reactor was then opened, and no presence of fouling was observed in it.

### Analysis

Where collected, the samples were treated as follows: the pyrolysis oil obtained (the liquids contained in the receiving liquids) was weighed and then subjected to ultracentrifugation (Thermo Scientific ultracentrifuge Sorvall Evolution RC model) at 25000 RPM for 45 minutes.

The fraction left on the bottom after ultracentrifugation (hereinafter referred to as wax fraction) and the supernatant (hereinafter referred to as the oil fraction) were separated and weighted.

The percentage of oil was calculated by dividing the weight of the oil fraction obtained by the weight of the material initially fed into the reactor.

The percentage of wax was calculated by dividing the weight of the wax fraction obtained by the weight of the material initially fed into the reactor.

The mass of gas produced was calculated as the difference between the weight of the material initially fed into the reactor and the sum of the weights of the wax and oil fraction. The gas fraction produced was calculated by dividing the mass of the gaseous fraction thus calculated by the weight of the material initially fed into the reactor.

The fractions obtained were analysed using the techniques described above. Approximately 130 chemical compounds were identified.

For each of these chemical compounds, the number of atoms of each element and, from the atomic mass of each atom, the mass fraction of the atoms were calculated.

The term “C5-C12 yield” refers to the sum of the mass of chemical compounds with 5 to 12 carbon atoms (extremes included) in the evaporated pyrolysis product with respect to the total mass fed. Similarly, “C21+yield” refers to the sum of the mass of chemical compounds with at least 21 carbon atoms in the evaporated pyrolysis product with respect to the total mass fed.

The term “C5-C12 fraction” refers to the sum of the mass of chemical compounds with 5 to 12 carbon atoms (extremes included) in a product with respect to the total mass thereof. Similarly, the term “fraction C21+” refers to the sum of the mass chemical compounds with at least 21 carbon atoms in a product with respect to the total mass thereof.

The term “evaporated pyrolysis product” therefore refers to the sum of the gas fraction, oil fraction and wax fraction, but not residual solid (char).

For this purpose, the gas chromatographic analysis was carried out separately on each of the gas, oil and wax fractions, then calculating the yield of a given compound “C” as follows:

$${x}_{C , VAP} = {f}_{GAS} \cdot {x}_{C , GAS} + {f}_{OIL} \cdot {x}_{C , OIL} + {f}_{WAX} \cdot {x}_{C , WAX}$$

Where:
X_{C, <FRAC>} is the mass fraction of compound C in the product fraction <FRAC> specified (<FRAC> is GAS=gaseous fraction, oil fraction or WAX=wax fraction). In the case of the GAS fraction, the fraction has been eliminated in advance from the calculation of nitrogen present (this being fed as an inert gas and not a pyrolysis product). The chromatogram of the GAS fraction gives the parts by volume that have been converted into parts by weight, assuming that the parts by volume correspond to the parts in moles and then calculating the parts by weight knowing the molecular weights of the compounds.
f_{OIL} and f_{WAX} are the mass fractions of the oil and wax fractions, respectively, obtained by dividing the weight of the collected material by the weight of the material fed into pyrolysis. The mass of the non-condensed vapours was assessed based on the volume of the expandable balloon and the density of the gas calculated based on the compositional analysis of the gases present therein. The mass of the solid residue in the reactor was then calculated by the difference between the mass of substantially plastic material fed and the sum of the mass of the pyrolysis oil collected (which also includes the waxes) and the mass of the gas assessed as follows:

$${M}_{CHAR} = {M}_{FEED} - ( {M}_{GAS} + {M}_{OIL} + {M}_{WAX} )$$

### Results

The following table shows the C5-C12 yield, the C21+yield (from 21 carbon atoms upwards), plus the content of some compounds and any fouling in the reactor:

| Example | UoM | 1 | 2 | 4 | 5 | 6 | 7 | 8 |
|---|---|---|---|---|---|---|---|---|
| Material | [—] | PATA | PATA | PATB | PATB | PATB | PATB | B02 |
| Pressure | [bara] | 1 | 5.5 | 1 | N.A. | 6.5 | 7.5 | 5.5 |
| RI | [nD] | 1,445 | 1,425 | 1,505 | 1.48 | 1.44 | 1.43 | 1.44 |
| VI | [cP] | 1.1 | 0.89 | 1.65 | 1.52 | 0.95 | 0.88 | 1.05 |
| Yield C5- | [wt. %] | 34% | 63% | 45% | 48% | 60% | 62% | — |
| C12 | | | | | | | | |
| Yield C21+ | [wt. %] | 3.8% | 0.19% | 4.1% | 3.5% | 0.6% | 0.4% | — |
| THF | [wt. %] | 0.0252% | 0.085% | 0.02% | 0.03% | 0.08% | 0.09% | — |
| benzoic | [wt. %] | 0.07% | 0.02% | 1.33% | 1.29% | 0.95% | 0.88% | — |
| acid | | | | | | | | |
| Isobutene | [wt. %] | 0.7% | 0.3% | 0.21% | 0.2% | 0.18% | 0.17% | — |
| Fouling | [—] | NO | NO | YES | YES | NO | NO | NO |
| in the | | | | | | | | |
| reactor | | | | | | | | |

The quantity of hydrocarbons in the pyrolysis oils obtained was always higher than 90% by weight. Examples 2,6 and 7 of the present invention showed a C5-C12 yield equal to at least 30% and, at the same time, a C21-and-higher yield (C21+) equal to at most 3%.

### Discussion of the Results

One of the objectives of the invention is to solve the critical issues relating to the pyrolysis of substantially plastic materials that vary greatly in composition, maintaining a high quality of pyrolysis products. Both mixtures from virgin materials of different composition and recycled materials were therefore assessed.

The experimentation carried out has shown that it is possible to carry out a stable feedback control with respect to parameters assessed on the pyrolysis oil obtained with low latency time, especially by assessing the transmission spectrum on these and carrying out an assessment of its property “Px”, such as the refractive index “RI” and/or viscosity “VI”.

Furthermore, the present invention shows that, by setting the feedback control set point within the specified ranges, the reactor is kept clean. In fact, Examples 1, 2, 6, 7 and 8 have both the viscosity and the refractive index falling within said ranges and the pyrolysis reactor, even after many hours of activity, was shown to be clean. On the other hand, Comparative Examples 6 and 7 show that, when set outside of said ranges, fouling problems can occur. Fouling is unwanted because it can obstruct the control bodies over time; it can be dragged into the pyrolysis oil produced and, by accumulating over time, can force a cleaning downtime.

Finally, the pyrolysis oil obtained in Examples 2, 6 and 7 (each with a C21+fraction of less than 3.5% and a C5-C12 fraction equal to at least 35%) was fed to a steam cracking pilot reactor, with good yield in monomers useful for the Formation of new polymers and without showing running problems or fouling.

Mixtures of virgin polymers were used to take advantage of the stability and knowledge of the substantially plastic material fed to the reactor, thus eliminating doubts relating to the inhomogeneity of the substantially plastic material. However, the test with the recycled material was also satisfactory.

1. A process for the pyrolysis of substantially plastic material to obtain at least hydrocarbons that are liquid at 25° C., comprising the following steps:
a) feeding a substantially plastic material to a pyrolysis reactor;
b) bringing said material in said pyrolysis reactor to a temperature of between 330° C. and 580° C. in substantial absence of oxygen and at a pressure of between atmospheric pressure and 13 bara;
c) maintaining said material in said pyrolysis reactor for a time sufficient to produce an effluent in the gaseous state;
d) partially or fully condensing said effluent in the gaseous state, so as to form at least one fluid comprising hydrocarbons that are liquid at 25° C. and which quantitatively is at least 10% by mass with respect to the mass of substantially plastic material fed;
e) carrying out an assessment of at least one property “Px” of the liquid condensed from said effluent in the gaseous state by means of at least one measurement “Ax” of the spectrum in transmission, reflection or transflexion of said condensed liquid, in which said “Ax” measurement is carried out directly on said condensed liquid by means of a spectrometer or spectrophotometer;
f) adjusting at least one process parameter “Ox” according to said assessment of at least one property “Px”;
g) repeating steps e) and f) iteratively so as to keep the said at least one property “Px” substantially constant over time.

2. The process for the pyrolysis of substantially plastic material according to claim 1, where said at least one property “Px” of the liquid condensed by said effluent in the gaseous state is the refractive index and/or the viscosity.

3. The process for the pyrolysis of substantially plastic material according to claim 2, where said at least one property “Px” of the liquid condensed by said effluent in the gaseous state is the refractive index.

4. The process for pyrolysis of substantially plastic material according to claim 2, wherein said at least one property “Px” of the liquid condensed by said effluent in the gaseous state is the viscosity.

5. The process for the pyrolysis of substantially plastic material according to claim 3, where said regulation of at least one process parameter “Ox” is carried out by setting a set point of the refractive index property “Px” to a value of between 1.415 and 1.465 nD, preferably between 1.42 and 1.455, more preferably between 1.425 and 1.45.

6. The process for pyrolysis of substantially plastic material according to claim 4, where said regulation of at least one process parameter “Ox” is carried out by setting a set point of the viscosity property “Px” to a value of between 0.7 and 1.2 cP, preferably between 0.8 and 1.1 cP, more preferably between 0.85 and 1.05 cP.

7. The process for the pyrolysis of substantially plastic material according to claim 1, where said parameter “Ox” is at least one of the following parameters: the pyrolysis pressure, the pyrolysis temperature, the residence time of the substantially plastic material in the pyrolysis reactor, the flow rate of the substantially plastic material in the pyrolysis reactor and the ratio of the flow rates between more than one substantially plastic material fed into the pyrolysis reactor.

8. The process for pyrolysis of substantially plastic material according to claim 1, where the latency time between the measurement of the spectrum “Ax” and its use in the regulation of the process parameter “Ox” can be set to a value not exceeding one hour, preferably not exceeding 10 minutes, more preferably between 1 and 60 seconds.

9. The process for the pyrolysis of substantially plastic material according to claim 1, wherein said step d) of partially or totally condensing said effluent in the gaseous state is obtained by partial condensation of the effluent in the gaseous state of said pyrolysis reactor by applying a cooling on at least a part of said effluent in the gaseous state.

10. The process for the pyrolysis of substantially plastic material according to claim 1, wherein said effluent in the gaseous state in step d) are directly the pyrolysis vapours included within said pyrolysis reactor or are the pyrolysis vapours included in the outlet duct of the pyrolysis vapours from said pyrolysis reactor.

11. The process for the pyrolysis of substantially plastic material according to claim 10, wherein, when said effluent in the gaseous state in step d) are the pyrolysis vapours included in the outlet duct of the pyrolysis vapours from said pyrolysis reactor, said vapours are carried to the area where at least partial condensation and said measurement “Ax” is performed within 2 minutes of the entry of said vapours into said outlet duct from the reactor, preferably between 1 and 60 seconds.

12. The process for pyrolysis of substantially plastic material according to claim 1, wherein step d) involves:
the withdrawal of a flow of pyrolysis vapours from the pyrolysis vapour outlet duct from the pyrolysis reactor;
sending said flow of vapours withdrawn to a condenser, so as to condense at least 50% of the vapours;
carrying out the measurement “Ax” on the condensed fluid, preferably in the lower part of the condenser, which acts as a liquid storage capacity;
sending the non-condensed vapours to the pyrolysis reactor, sending them to a pyrolysis vapour outlet duct or sending them to the remaining pyrolysis vapours before the condensation of step d) of the process;
sending the liquid into the pyrolysis reactor or into said pyrolysis vapour outlet duct, preferably by gravity, thus returning the liquid into the main flow.

13. The process for the pyrolysis of substantially plastic material according to claim 1, including the obtaining of at least one calibration curve “Cx” capable of correlating the spectrum in transmittance, transflectance or reflectance of the hydrocarbon liquid obtained by pyrolysis with the values of at least one property “Px” of said hydrocarbon liquid, wherein the calibration curve “Cx” is obtained by applying a multivariate regression method, preferably multiple linear regression (MLR), principal component analysis (PCR) regression or partial least squares (PLS) regression.

14. The process for the pyrolysis of substantially plastic material according to claim 1, wherein, when the measurement “Ax” is carried out in transmission or transflexion mode, the optical path of the light is less than 25 mm, or between 3 and 18 mm, or between 5 and 15 mm, or between 7 and 11 mm.

15. The process for the pyrolysis of substantially plastic material according to claim 1, wherein the measurement “Ax” is carried out by means of a probe capable of emitting light, with a wave number of at least between 4000 and 12000 cm⁻¹, or between 4500 and 10000 cm⁻¹, or between 5000 and 9000 cm⁻¹.

16. A mixture obtained from the process according to claim 1, comprising hydrocarbons for at least 90% by weight, with a refractive index, measured according to the method defined below, of between 1.415 and 1.465 nD, preferably between 1.42 and 1.455, even more preferably between 1.425 e 1.45 and a viscosity, measured according to the method defined below, of between 0.7 and 1.2 cP, preferably between 0.8 and 1.1 cP, even more preferably between 0.85 and 1.05 cP and with a tetrahydrofuran (THF) content equal to no more than 1% by weight, preferably between 0.01% and 0.25% by weight, even more preferably between 0.07 and 0.19% by weight, with respect to the overall weight of the mixture.

17. The mixture comprising hydrocarbons for at least 90% by weight according to claim 16, further characterized by a C5-C12 content equal to at least 35% by weight, a C21-and-higher content equal to at most 3.5% by weight, isobutene no higher than 0.55%, preferably between 0.15% and 0.3% by weight and/or benzoic acid not exceeding 2% by weight, preferably between 0.01 and 1% by weight, where all percentages are compared with the total weight of the mixture.

18. A method of feeding a steam cracking plant, comprising feeding the mixture according to claim 16 to obtain monomers useful for producing polymers.

19. An apparatus for the pyrolysis of substantially plastic material to obtain at least hydrocarbons that are liquid at 25° C. comprising:
at least one reactor for the pyrolysis of substantially plastic material;
at least one condensation separator which receives the vapours from said at least one pyrolysis reactor and carries out an at least partial condensation thereof;
at least one device that performs the measurement “Ax” of the spectrum in transmission, reflection or transflexion of the liquid condensed from said effluent in the gaseous state, wherein said “Ax” measurement is performed directly on said condensed liquid by means of a spectrometer or spectrophotometer;
at least one system which assesses at least one property “Px” of the liquid condensed from said effluent in the gaseous state by means of at least said measurement “Ax”;
at least one regulation system on a process parameter “Ox” as a function of said measurement “Ax” of said at least one property “Px”.
